(19) United States
(12) Patent Application Publication
(10) Pub. No.: US 2024/0353129 A1
(43) Pub. Date: Oct. 24, 2024

(54) AIR CONDITIONING DEVICE AND METHOD FOR ADSORBING CARBON DIOXIDE

(71) Applicants: SAMSUNG ELECTRONICS CO., LTD., Suwon-si (KR); KOREA UNIVERSITY RESEARCH AND BUSINESS FOUNDATION, Seoul (KR)

(72) Inventors: Minkyung LEE, Suwon-si (KR); Yongtae KANG, Seoul (KR); Kwangjoo KIM, Suwon-si (KR); Youngdeog KOH, Suwon-si (KR); Minjae KIM, Seoul (KR); Seonggon KIM, Seoul (KR); Jaewon LEE, Seoul (KR)

(73) Assignees: SAMSUNG ELECTRONICS CO., LTD., Suwon-si (KR); KOREA UNIVERSITY RESEARCH AND BUSINESS FOUNDATION, Seoul (KR)

(21) Appl. No.: 18/742,477

(22) Filed: Jun. 13, 2024

Related U.S. Application Data
(63) Continuation of application No. PCT/KR2024/002555, filed on Feb. 28, 2024.

(30) Foreign Application Priority Data
Feb. 28, 2023 (KR) 10-2023-0027254
Mar. 17, 2023 (KR) 10-2023-0035185

(51) Int. Cl. F24F 7/003; F24F 7/08; F24F 8/158; F24F 8/90

(52) U.S. Cl. CPC F24F 7/003; F24F 7/08; F24F 8/158; F24F 8/90

(57) ABSTRACT

An air conditioning device configured so that, in a circulation operation state, a first air passage connecting a first intake port and a first discharge port is formed to move indoor air through the first intake port, through a carbon dioxide suction filter, and through the first discharge port to the indoor area, and, in a ventilation operation state, a second air passage connecting the first intake port and a second discharge port is formed to move indoor air from through the first intake port, through the carbon dioxide suction filter, and through the second discharge port to the outdoor area while a heater heats the carbon dioxide suction filter, and a third air passage connecting a second intake port to the first discharge port is formed to move outdoor air from the outdoor area through the second intake port, and through the first discharge port to the indoor area.

### CROSS-REFERENCE TO RELATED APPLICATIONS

This application is a continuation application, under 35 U.S.C. § 111(a), of International Application No. PCT/KR2024/002555, filed on Feb. 28, 2024, which claims priority under 35 U.S.C. § 119 to Korean Patent Application 10-2023-0027254, filed on Feb. 28, 2023, and Korean Patent Application 10-2023-0035185, filed on Mar. 17, 2023, in the Korean Intellectual Property Office, the disclosures of which are incorporated by reference herein in their entireties.

### BACKGROUND

### 1. Field

The disclosure relates to an air conditioning device and method for reducing indoor carbon dioxide concentration through a carbon dioxide suction filter.

### 2. Description of Related Art

Air conditioning devices, such as air purifiers or ventilators, may be used to control indoor air quality. The air conditioning device may be referred to as an energy recovery ventilator (ERV) or a total heat exchanger. In the air conditioning device, heat exchange may occur between air discharged from indoors to outdoors and air introduced from outdoors to indoors.

The air conditioning device may have a filter to remove harmful substances. The type of filter applied to the air conditioning device may vary depending on the object to be removed, such as particulate matter, yellow dust, pollen, or bacteria.

In closed spaces, such as indoors, existence of high concentration of carbon dioxide (CO₂) may be harmful to the human body. For example, breathing and cooking in a closed space may increase the carbon dioxide concentration. Continuous exposure to a high concentration of carbon dioxide may result in discomfort, poor concentration, or headaches. The average concentration level of carbon dioxide outdoors is about 400 to 500 ppm (parts per million), and the optimal concentration level of carbon dioxide indoors is 1000 ppm or less.

Ventilation may reduce indoor carbon dioxide concentration by circulating outdoor and indoor air. However, energy loss may during ventilation, requiring energy consumption or usage for cooling or heating.

Accordingly, the air conditioning device may lower the concentration of indoor carbon dioxide by applying a filter to remove (or reduce) the level of carbon dioxide therein. As an example, a filter mounted on the air conditioning device may filter or remove carbon dioxide, thereby reducing the indoor carbon dioxide concentration.

### SUMMARY

One embodiment of the disclosure may provide an air conditioning device that removes carbon dioxide suctioned by a filter in a passage discharging indoor air to the outside using a low-temperature heat source.

Aspects of embodiments of the disclosure will be set forth in part in the description which follows and, in part, will be apparent from the description, or may be learned by practice of the presented embodiments.

According to an embodiment of the disclosure, an air conditioning device includes a main body provided with a first intake port through which indoor air is movable from an indoor area, a first discharge port through which supply air is movable to the indoor area, a second intake port through which outdoor air is movable from an outdoor area, and a second discharge port through which exhaust air is movable to the outdoor area; and wherein the main body includes a carbon dioxide suction filter provided in a section where a first air passage connecting the first intake port and the first discharge port and a second air passage connecting the first intake port (121) and the second discharge port (127) are common; and a heater configured to heat the carbon dioxide suction filter to a predetermined temperature based on an operation state of which the air conditioning device discharge indoor air to the outdoor area and supply outdoor air to the indoor area.

According to an embodiment of the disclosure, an air conditioning device includes a first intake port through which indoor air is movable from an indoor area; a first discharge port through which supply air is movable to the indoor area; a second intake port through which outdoor air is movable from an outdoor area; a second discharge port through which exhaust air is movable to the outdoor area; a carbon dioxide suction filter; and a heater configured to heat the carbon dioxide suction filter to a predetermined temperature based on an operation state of the air conditioning device, wherein the air condition device is configured so that, in a circulation operation state, a first air passage connecting the first intake port and the first discharge port is formed such that indoor air is moved from the indoor area through the first intake port, thereafter through the carbon dioxide suction filter, and thereafter through the first discharge port to the indoor area as supply air without the heater heating the carbon dioxide suction filter, and, in a ventilation operation state, a second air passage connecting the first intake port and the second discharge port is formed such that indoor air is moved from the indoor area through the first intake port, thereafter through the carbon dioxide suction filter, and thereafter through the second discharge port to the outdoor area as exhaust air while the heater heats the carbon dioxide suction filter, and a third air passage connecting the second intake port to the first discharge port is formed such that outdoor air is moved from the outdoor area through the second intake port, and thereafter through the first discharge port to the indoor area as supply air.

According to an embodiment of the disclosure, a suction capacity of the carbon dioxide suction filter may be 1.5 mmol/g to 2.5 mmol/g.

According to an embodiment of the disclosure, the air conditioning device may further include at least one of a first damper configured to open and close the first intake port, a second damper configured to open and close the first discharge port, a third damper configured to open and close the second intake port, and a fourth damper configured to open and close the second discharge port.

According to an embodiment of the disclosure, the heater may be configured to heat the carbon dioxide suction filter to 65° C. to 70° C.

According to an embodiment of the disclosure, the carbon dioxide suction filter may include an adsorbent including a material in which carbon nanofibers, nanoparticles, and an amine group are combined at a predetermined component ratio. The carbon nanofibers may include carbon nanotubes (CNTs) and/or graphene nanofibers (GNFs). The nanoparticles may include at least one of silicon dioxide (SiO₂), aluminum oxide (Al₂O₃), iron oxide (Fe₃O₄), and titanium dioxide (TiO₂). The amine group may include at least one or polyethylenimine (PEI), 3-aminopropyl triethoxysilane, tetraethylenepentamine, and diethylenetriamine.

According to an embodiment of the disclosure, a molecular weight of the amine group may be 600 to 25,000.

According to an embodiment of the disclosure, the material of the adsorbent may have a bead shape through a phase inversion method.

According to an embodiment of the disclosure, the carbon dioxide suction filter may include an adsorbent formed of a material in which an amine group is bonded to at least one synthetic resin-based adsorbent. The material of the adsorbent may have a capsule form through a phase inversion method.

According to an embodiment of the disclosure, the air conditioning device may further include a bypass damper through which bypass exhaust air is movable to the outdoor area. The air condition device may be configured so that, in a bypass ventilation operation state, a fourth air passage connecting the first intake port and the bypass damper is formed such that indoor air is moved from the indoor area through the first intake port, thereafter through the carbon dioxide suction filter, and thereafter through the bypass damper to the outdoor area as bypass exhaust air while the heater heats the carbon dioxide suction filter, and the third air passage connecting the second intake port to the first discharge port is formed such that outdoor air is moved from the outdoor area through the second intake port, and thereafter through the first discharge port to the indoor area as supply air.

According to an embodiment of the disclosure, provided is a method of driving an air conditioning device including a first intake port through which indoor air is movable from an indoor area, a first discharge port through which supply air is movable to the indoor area, a second intake port through which outdoor air is movable from an outdoor area, a second discharge port through which exhaust air if movable to the outdoor area, a carbon dioxide suction filter, and a heater configured to heat the carbon dioxide suction filter to a predetermined temperature based on an operation state of the air conditioning device, the method including determining whether a current operation state is a circulation operation state or a ventilation operation state; and if the determined current operation state is the ventilation operation state to discharge indoor air to the outdoor area and supply outdoor air to the indoor area, heating the carbon dioxide suction filter to a predetermined temperature in response to determining that the operation state is the ventilation operation state for discharging the indoor air outdoors and supplying outdoor air indoors.

According to an embodiment of the disclosure, provided is a method of driving an air conditioning device including a first intake port through which indoor air is movable from an indoor area, a first discharge port through which supply air is movable to the indoor area, a second intake port through which outdoor air is movable from an outdoor area, a second discharge port through which exhaust air if movable to the outdoor area, a carbon dioxide suction filter, and a heater configured to heat the carbon dioxide suction filter to a predetermined temperature based on an operation state of the air conditioning device, the method including determining whether a current operation state is a circulation operation state or a ventilation operation state; if the determined current operation state is the circulation operation state, forming a first air passage connecting the first intake port and the first discharge port such that indoor air is moved from the indoor area through the first intake port, thereafter through the carbon dioxide suction filter, and thereafter through the first discharge port to the indoor area as supply air, without operating the heater to heat the carbon dioxide suction filter, and, if the determined current operation state is the ventilation operation state, forming a second air passage connecting the first intake port and the second discharge port such that indoor air is moved from the indoor area through the first intake port, thereafter through the carbon dioxide suction filter, and thereafter through the second discharge port to the outdoor area as exhaust air, while operating the heater to heat the carbon dioxide suction filter, and forming a third air passage connecting the second intake port to the first discharge port such that outdoor air is moved from the outdoor area through the second intake port, and thereafter through the first discharge port to the indoor area as supply air.

According to an embodiment of the disclosure, the air conditioning device may include a bypass damper through which bypass exhaust air is movable to the outdoor area, and the method may further include determining whether a current operation state is a bypass ventilation operation state; and, if the determined current operation state is the bypass ventilation operation state, forming a fourth air passage connecting the first intake port and the bypass damper such that indoor air is moved from the indoor area through the first intake port, thereafter through the carbon dioxide suction filter, and thereafter through the bypass damper to the outdoor area as bypass exhaust air, while operating the heater to heat the carbon dioxide suction filter, and forming the third air passage connecting the second intake port to the first discharge port such that outdoor air is moved from the outdoor area through the second intake port, and thereafter through the first discharge port to the indoor area as supply air.

According to an embodiment of the disclosure, the operating the heater to heat the carbon dioxide suction filter may include heating the carbon dioxide suction filter to 65° C. to 70° C.

According to an embodiment of the disclosure, the method may further include detecting an indoor carbon dioxide concentration, and if the detected carbon dioxide concentration level exceeds a first threshold level, determining that the current operation state is the circulation operation state.

According to an embodiment of the disclosure, the first threshold level is 1200 ppm.

According to an embodiment of the disclosure, the method may further include, based on the detected carbon dioxide concentration level being less than or equal to a second threshold level, or based on a suction capacity of the carbon dioxide suction filter being exceeded, determining that the current operation state is the ventilation operation state. The second threshold level may be lower than the first threshold level.

According to an embodiment of the disclosure, the second threshold level is 1200 ppm.

According to an embodiment of the disclosure, provided is a method of controlling an air conditioning device including a first flow passage through which indoor air is movable from an indoor area to an outdoor area, a carbon dioxide suction filter in the first flow passage, a heater to heat the carbon dioxide suction filter, and a second flow passage through which outdoor air is movable from the outdoor area to the indoor area, the method including operating the air conditioning device in a ventilation mode in which indoor air is drawn from an indoor area into the first passage and passed through a carbon dioxide suction filter before being discharged to an outdoor area, and in which outdoor air is draw from an outdoor area into second flow passage and discharged into the indoor area; and heating the carbon dioxide suction filter to a predetermined temperature while operating the air conditioning device in the ventilation mode.

According to an embodiment of the disclosure, the operating the heater to heat the carbon dioxide suction filter may include heating the carbon dioxide suction filter to 65° C. to 70° C.

According to an embodiment of the disclosure, it is possible to enhance indoor air quality by removing indoor carbon dioxide through a filter to which a carbon dioxide adsorbent is applied in an air conditioning device and to desorbed carbon dioxide adsorbed to the filter by a heat source in a lower-temperature area to reproduce the filter and accordingly enable continuous use.

The technical objects of the disclosure are not limited to the foregoing, and other technical objects may be derived by one of ordinary skill in the art from example embodiments of the disclosure.

Effects of the present invention are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view illustrating an example air conditioning device according to various embodiments;

FIG. 2 is a block diagram illustrating an example air conditioning device according to various embodiments;

FIG. 3 is a front view illustrating an example air conditioning device according to various embodiments;

FIG. 4 is a flowchart illustrating an example control for selecting an operation type of an air conditioning device according to various embodiments;

FIG. 5 is a flowchart illustrating an example subroutine for a circulation operation in an air conditioning device according to various embodiments;

FIG. 6 illustrates an example air flow during a circulation operation in an air conditioning device according to various embodiments;

FIG. 7 is a flowchart illustrating an example control of a subroutine for a circulation operation in an air conditioning device according to various embodiments;

FIG. 8 illustrates an example air flow during a ventilation operation in an air conditioning device according to various embodiments;

FIG. 9A illustrates an example air flow for removing carbon dioxide adsorbed to a filter during a ventilation operation in an air conditioning device according to various embodiments;

FIG. 9B illustrates an example air flow for removing carbon dioxide adsorbed to a filter during a ventilation operation in an air conditioning device according to various embodiments;

FIG. 10 is a flowchart illustrating an example control of a subroutine for operating an automatic mode in an air conditioning device according to various embodiments; and

FIG. 11 is a front view illustrating an example of indoor air being discharged to outdoors through a bypass path in an air conditioning device according to various embodiments.

The same or similar reference denotations may be used to refer to the same or similar elements throughout the specification and the drawings.

### DETAILED DESCRIPTION

Various embodiments of the disclosure are now described in greater detail with reference to the accompanying drawings. However, the disclosure may be implemented in other various forms and is not limited to the embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

For use in embodiments of the disclosure, common terms widely used as possible have been chosen considering functions in the disclosure, but the terms may be varied depending on the intent of one of ordinary skill in the art or case laws or the advent of new technologies. Accordingly, the terms used herein should be determined based on their meanings and the overall disclosure, rather than by the terms themselves.

In various embodiments of the disclosure, if an element “includes” another element, the element may further include the other element, rather excluding the other element, unless particularly stated otherwise.

The expression “at least one of A and/or B” should be understood to represent “A” or “B” or any one of “A and B.”

For example, the expression “at least one of A and B” includes any of the following: A, B, A and B. The expression “at least one of A, B, and C” includes any of the following: A, B, C, A and B, A and C, B and C, A and B and C. The expression “at least one of A, B, C, and D” includes any of the following: A, B, C, D, A and B, A and C, A and D, B and C, B and D, C and D, A and B and C, A and B and D, A and C and D, B and C and D, A and B and C and D.

Hereinafter, the terms used in the disclosure are previously defined as follows.

Outdoor air (OA) refers to the air outside closed space or structure (e.g., building) and further refers to air before being introduced into the air conditioning device. The OA may also be referred to as ambient air or open air.

Indoor air (or return air (RA)) refers to the air inside closed space or structure and further refers to the air that is to be ventilated and/or introduced into the air conditioning device. The RA may also be referred to as interior air or internal air.

Exhaust air (EA) refers to the air discharged from indoors to outdoors through the air conditioning device.

Supply air (SA) refers to the air supplied indoors through the air conditioning device. The SA may include the OA that is supplied indoors through the air conditioning device and the RA that is circulated indoors through the air conditioning device.

The terms “x-axis direction”, “y-axis direction”, and “z-axis direction” used in the following description are defined with reference to the drawings for convenience of description, and the shape and position of each component are not limited by these terms.

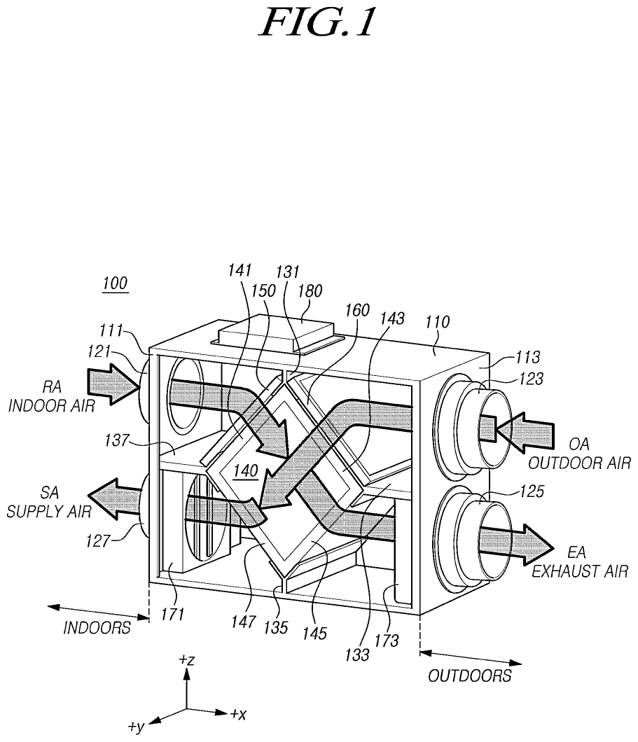

FIG. 1 is a perspective view of an example air conditioning device 100 according to various embodiments.

Referring to FIG. 1, the air conditioning device 100 may include a ventilation device such as a ERV or a total heat exchanger. Further, the air conditioning device 100 may be applied to various devices including air purifiers or air conditioners to purify or circulate air. In the disclosure, the air conditioning device 100 is described as being specific to the ERV but may be applied to various devices.

According to an embodiment, if the air conditioning device 100 is viewed from the front side to the rear side (−y-axis direction), the directions of the air conditioning device 100 may be defined as follows. For example, the +x-axis direction may be defined as a right direction of the air conditioning device 100, and the −x-axis direction may be defined as a left direction of the air conditioning device 100. For example, the +y-axis direction may be defined as a front direction of the air conditioning device 100, and the −y-axis direction may be defined as a rear direction of the air conditioning device 100. For example, the +z-axis direction may be defined as an upper direction of the air conditioning device 100, and the −z-axis direction may be defined as a lower direction of the air conditioning device 100.

The air conditioning device 100 may include a main body 110. The main body 110 may form an outer appearance of the air conditioning device 100. Components included in the air conditioning device 100 may be installed (or provided) in the main body 110.

According to an embodiment, the air conditioning device 100 may be installed or arranged so that the left side faces indoors (e.g., allow the RA to flow) and the right side faces outdoors (e.g., allow the OA to flow) with respect to the main body 110.

The air conditioning device 100 may be provided with a passage for introducing or discharging the OA and the RA. For example, the air conditioning device 100 may include one or more first intake ports 121 for introducing the RA. For example, the air conditioning device 100 may include one or more second intake ports 123 for introducing outdoor air or the OA. For example, the air conditioning device 100 may include one or more first discharge ports 127 for supplying air indoors (e.g., indoor air). For example, the air conditioning device 100 may include one or more second discharge ports 125 for discharging air outdoors (e.g., outdoor air). The one or more first intake ports 121 or the one or more first discharge ports 127 may be provided on a first side 111 corresponding to the left side of the main body 110. The one or more second intake ports 123 or the one or more second discharge ports 125 may be provided on a second side 113 corresponding to the right side of the main body 110.

In other example embodiments, the one or more first intake ports 121 or the one or more first discharge ports 127 may not be disposed on the same side. The one or more second intake ports 123 or the one or more second discharge ports 125 may not be disposed on the same side.

For example, the one or more first intake ports 121 may be provided on the first side 111 which is the left side, and the one or more first discharge ports 127 may be provided on the upper side. Conversely, the one or more first intake ports 121 may be provided on the upper side, and the one or more first discharge ports 127 may be provided on the first side 111 that is the left side.

For example, the one or more second intake ports 123 may be provided on the second side 113 which is the right side, and the one or more second discharge ports 125 may be provided on the upper side. Conversely, the one or more second intake ports 123 may be provided on the upper side, and the one or more second discharge ports 125 may be provided on the second side 113 which is the right side.

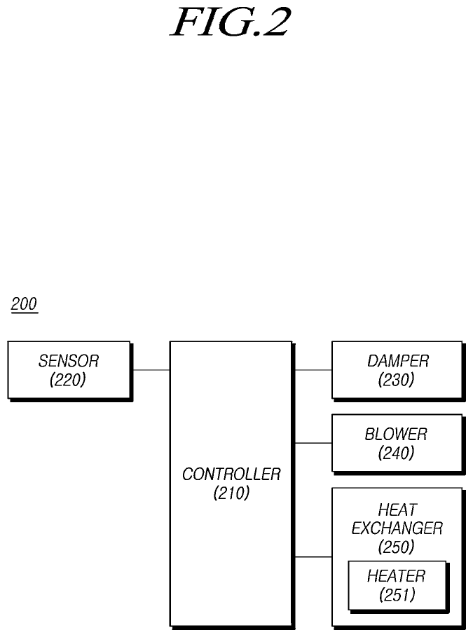

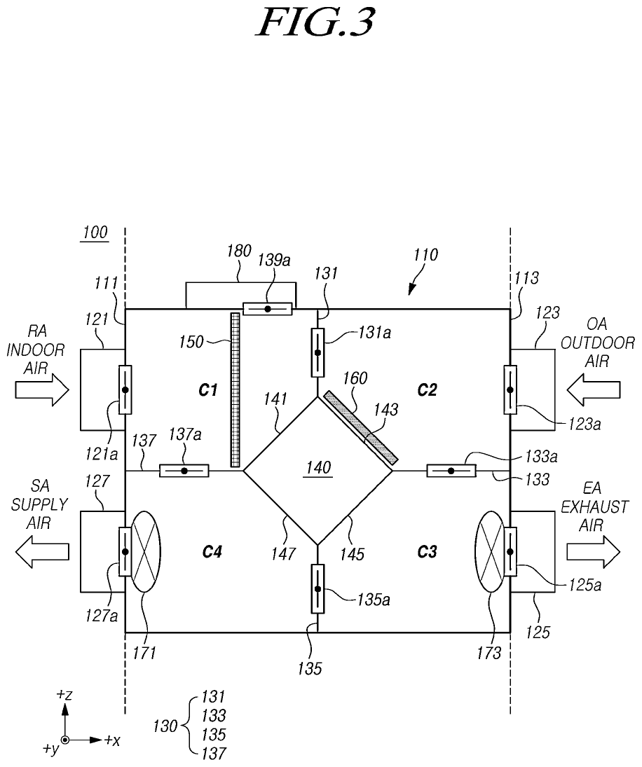

According to an embodiment, the air conditioning device 100 may include a damper (not shown in FIG. 1) (e.g., the damper 230 of FIG. 2) to facilitate flow of the OA and the RA. The damper 230 may be implemented as a valve or an orifice. The damper 230 may include, e.g., a first damper (e.g., the first damper 121a of FIG. 3), a second damper (e.g., the second damper 123a of FIG. 3), a third damper (e.g., the third damper 125a of FIG. 3), or a fourth damper (e.g., the fourth damper 127a of FIG. 3). The air conditioning device 100 may selectively open or close the plurality of dampers 121a, 123a, 125a, and 127a, included in the damper 230, to form (or create or allow) an air flow. The damper 230 may be provided near the intake ports 121 and 123 or the discharge ports 125 and 127. The damper 230 is described below in detail with reference to FIG. 3.

The air conditioning device 100 may exchange the OA and the RA. The air conditioning device 100 may exchange thermal energy of the outdoor air with thermal energy of the RA. For example, the air conditioning device 100 may include a heat exchanger 140.

The air conditioning device 100 may discharge the contaminated (or polluted) RA to outdoors (or outside) and supply the OA to indoors (or inside). For example, the air conditioning device 100 may purify the OA and supply the purified OA to indoors. The air conditioning device 100 may include at least one filter 150 or 160 to purify the OA.

According to an embodiment, the at least one filter 150 or 160 included in the air conditioning device 100 may include a first filter 150. The at least one filter 150 or 160 may include a second filter 160. The at least one filter 150 or 160 may include the first filter 150 and the second filter 160. The at least one filter 150 or 160 may include a filter casing forming an external appearance and an adsorbent. The performance or adsorption material of the at least one filter 150 or 160 may be determined according to the material or constituent materials of the adsorbent.

For example, the first filter 150 may be provided to adsorb carbon dioxide. The first filter 150 may be provided at a predetermined point in a section where the first air passage through which the RA is introduced into the air conditioning device 100 and supplied as the SA and the second air passage through which the RA is discharged as the EA are common (or shared). The first filter 150 may be provided, e.g., on the surface of the heat exchanger 140. The first filter 150 may be provided on a surface of the first plate 141 of the heat exchanger 140. Although not shown, the first filter 150 may be provided on the surface of the third plate 145 of the heat exchanger 140.

For example, the second filter 160 may be provided to adsorb harmful or contaminated substances. The second filter 160 may be provided on a third air passage through which the OA is introduced into the air conditioning device 100 and supplied as the SA. The second filter 160 may be provided, e.g., on the surface of the heat exchanger 140. The second filter 160 may be provided on the surface of the second plate 143 of the heat exchanger 140. Although not shown, the second filter 160 may be provided on the surface of the fourth plate 147 of the heat exchanger 140.

The air conditioning device 100 may include at least one blower 171 and 173. The at least one blower 171 or 173 may be provided to control the flow of air inside the air conditioning device 100. The at least one blower (171 or 173) may include, e.g., a first blower 171 forming a flow of air for discharging air indoors. The at least one blower 171 or 173 may include, e.g., a second blower 173 forming a flow of air for discharging air outdoors.

The air conditioning device 100 may include a power supply unit 180. The power supply unit 180 may include various circuitry and may be provided to supply driving power of the air conditioning device 100. For example, the power supply unit 180 may supply power required for driving the heat exchanger 140. For example, the power supply unit 180 may supply power required to open or close the damper 230. For example, the power supply unit 180 may supply power required for driving the at least one blower (171 or 173). Further, the power supply unit 180 may supply power necessary for driving the air conditioning device 100.

FIG. 2 is a block diagram of an example air conditioning device 200 (e.g., the air conditioning device 100 of FIG. 1) according to various embodiments.

Referring to FIG. 2, the air conditioning device 200 may include a controller 210, a sensor 220, a damper 230, a blower 240, or a heat exchanger 250. The heat exchanger 250 may include a heater 251. Further, the air conditioning device 200 may further include or omit components as necessary.

The sensor 220 may include various circuitry and detect a state inside or outside the air conditioning device 200. The sensor 220 may detect temperature or humidity inside or outside the air conditioning device 200. The sensor 220 may detect the concentration of gas inside or outside the air conditioning device 200. The sensor 220 may transmit the detected information to the controller 210.

For example, the sensor 220 may include at least one sensor. The at least one sensor may include a temperature sensor, a humidity sensor, or a gas sensor. The temperature sensor may detect an indoor temperature. The humidity sensor may detect indoor humidity.

For example, the sensor 220 may include a temperature sensor. The temperature sensor may be provided to detect an indoor temperature or a temperature of a carbon dioxide adsorption filter (e.g., the first filter 150 of FIG. 3).

For example, the sensor 220 may include a gas sensor. The gas sensor may detect the concentration of a specific gas. The gas sensor may detect the concentration of, e.g., carbon dioxide (CO₂), carbon monoxide (CO), hydrogen sulfide (H₂S), ammonia (NH₃), hydrocarbon (CₓH_{y}), nitrogen oxides (NOx), and radon. Hereinafter, in the description of the disclosure, the sensor unit 220 is described as a gas sensor that detects carbon dioxide.

According to an embodiment, the sensor 220 may detect the concentration of carbon dioxide in the RA. The outdoor average concentration level of carbon dioxide corresponds to, e.g., 400 to 500 ppm (parts per million, 10⁻⁶ g/g), and the acceptable and/or recommended indoor appropriate concentration level of carbon dioxide is, e.g., 1000 ppm or less. If the human body is continuously exposed to the concentration of 1000 or more ppm of carbon dioxide, the body may experience discomfort, decreased concentration, or headache. Information about the indoor carbon dioxide concentration level detected by the sensor unit 220 may be transmitted to the controller 210.

According to an embodiment of the disclosure, the sensor 220 may detect the concentration level of carbon dioxide present in the filter (e.g., the carbon dioxide adsorption filter) provided in the air conditioning device 200. The sensor 220 may transmit the detected carbon dioxide concentration information to the controller 210.

The damper 230 may be provided to flow the OA or the RA passing through the air conditioning device 200. The damper 230 may be opened or closed to pass gas (e.g., air). In addition to the damper, the damper 230 may be implemented as a valve or an orifice.

According to an embodiment of the disclosure, the damper 230 may include various circuitry and may be opened or closed by a signal transmitted from the controller 210. For example, the controller 210 may transmit a signal for opening or closing the damper 230. The damper 230 may obtain the signal and alternately perform an opening or closing operation. To that end, the damper 230 may be configured as a toggle switch or may include a toggle switch.

According to an embodiment of the disclosure, the damper 230 may include at least one damper. The damper 230 may be provided in a passage through which the OA or the RA enters and exits. The damper 230 may be provided on a partition wall 133 to allow gas to enter and exit the partition (e.g., the second partition wall 133 of FIG. 3) partitioning the air conditioning device 200.

The blower 240 may include various circuitry and may be provided to move the gas in a specific direction. For example, the blower 240 may include a supply air blower (e.g., the first blower 171 of FIG. 3) or an exhaust blower (e.g., the second blower 173 of FIG. 3). The supply air blower 171 may be provided to supply air indoors. The exhaust blower 173 may be provided to discharge air outdoors. Further, the blower 240 may be additionally provided in the air conditioning device 200 to form an air flow.

According to an embodiment of the disclosure, the blower 240 may be implemented as a fan. The blower 240 may be implemented as various types of fans, including a turbo fan, a radial fan, a sirocco fan, or an axial fan.

According to an embodiment of the disclosure, the blower 240 may be operated (switched-on) or stopped (switched-off) by the controller 210. The blower 240 may be operated or stopped by an electrical signal transmitted from the controller 210. To that end, the blower 240 may include a toggle switch.

The heat exchanger 250 may include various circuitry and may be provided to exchange thermodynamic energy between the OA and the RA. The heat exchanger 250 may be implemented as a total heat exchange element (e.g., the heat exchanger 140 of FIG. 1). The heat exchanger 250 may adjust a temperature difference between the outside air and the inside air. The heat exchanger 250 may exchange sensible heat or latent heat contained in the outside air or the inside air.

The heat exchanger 250 may be operated by the controller 210. The heat exchanger 250 may be operated or stopped by a signal transmitted by the controller 210.

According to an embodiment of the disclosure, the heat exchanger 250 may include a heater 251. The heater 251 may be implemented integrally with or independently of the heat exchanger 250.

For example, the heater 251 may include various circuitry and may heat a carbon dioxide adsorption filter (e.g., the first filter 150 of FIG. 3) to a predetermined temperature (e.g., 65° C. to 70° C.). The heater 251 may heat the filter 150 to desorb carbon dioxide adsorbed to the filter unit.

According to an embodiment of the disclosure, the heater 251 may be provided near the first filter 150 to heat the first filter 150. For example, the heater 251 may be implemented in the form of a heating wire installed around the first filter 150. The heater 251 may be driven with power supplied by an external power source.

According to an embodiment of the disclosure, the heater 251 may be operated or stopped by the controller 210. The heater 251 may be operated or stopped by a control signal transmitted from the controller 210.

The controller 210 may include various circuitry and control the overall operation to be performed by the air conditioning device 200. The controller 210 may remotely control the air conditioning device 200 by communicating with a server (not shown).

The controller 210 may transmit or receive an electrical signal to/from one or a plurality of components included in the air conditioning device 200.

For example, the controller 210 may obtain information detected by the sensor 220.

For example, the controller 210 may transmit a switching signal so that the damper 230 is alternately opened or closed.

For example, the controller 210 may transmit a switching signal so that the blower 240 is operated or stopped.

For example, the controller 210 may transmit a switching signal so that the heat exchanger 250 is operated or stopped.

For example, the controller 210 may transmit a switching signal so that the heater 251 is operated or stopped.

According to an embodiment of the disclosure, the controller 210 may select an operation mode of the air conditioning device 200. For example, the driving mode may be selected by the user's manipulation. The operation mode may include, e.g., a ventilation operation mode, a circulation operation mode, and an automatic driving mode. The ventilation operation mode may refer to a mode in which the OA is supplied indoors and the RA is discharged outdoors. The circulation operation mode may refer to a mode in which the RA is purified inside the air conditioning device 200 and supplied back indoors. The automatic driving mode may mean a mode of driving in at least one of the ventilation mode or the circulation mode based on the concentration of indoor carbon dioxide.

For example, the controller 210 may determine to operate in the ventilation mode based on the indoor carbon dioxide concentration detected by the sensor 220. The ventilation mode may refer to an operation mode for adsorption of carbon dioxide in the RA to the filter 150 provided inside the air conditioning device 200. If the indoor carbon dioxide concentration level exceeds a threshold concentration level, the controller 210 may execute the ventilation mode. The threshold concentration level may be, e.g., 1200 ppm. The controller 210 may allow operation in the ventilation mode until the indoor carbon dioxide concentration level decreases below the threshold concentration level. The threshold concentration level may be, e.g., 1000 ppm.

For example, if the concentration level of the indoor carbon dioxide is less than or equal to the threshold concentration level or the concentration level of the carbon dioxide collected in the filter 150 exceeds a threshold capacity, the controller 210 may operate the heater 251 to remove the carbon dioxide collected in the filter 150. The threshold concentration level may be, e.g., 1000 ppm. The controller 210 may operate the heater 251 to heat the filter 150 to a predetermined temperature. The predetermined temperature may be, e.g., 65° C. to 70° C. The controller 210 may control to operate in the ventilation mode to discharge carbon dioxide controlled by the filter 150 outdoors.

According to an embodiment of the disclosure, as carbon dioxide adsorbed to the filter 150 is removed at a relatively low temperature, energy used to regenerate the filter 150 may be reduced.

Although not shown, the air conditioning device 200 may include a communication module. The communication module may receive an input generated by the user's manipulation. For example, the communication module may include an infrared transmission/reception module. The communication module may receive a signal generated by the controller (e.g., a remote controller).

For example, the communication module may include a wireless communication module. The communication module may transmit the operation state of the air conditioning device 200 to an external electronic device (e.g., the user terminal) using Wi-Fi and Bluetooth.

Although not shown, the air conditioning device 200 may include a display module (e.g., a display). The display module may be provided integrally with the air conditioning device 200 or may be provided independently outside the air conditioning device 200. If the display module is integrally implemented with the air conditioning device 200, the display module may be provided on any one surface of the surfaces of the air conditioning device 200 (e.g., one outer surface of the body 110 of FIG. 3). For example, the display module may display a currently operating operation mode or an indoor air state (e.g., temperature, humidity, fine dust, carbon dioxide concentration).

FIG. 3 is a front view of an example air conditioning device 100 (e.g., the air conditioning device 100 of FIG. 1) according to various embodiments. In other words, it is a front view of the air conditioning device 100 viewed in the −y-axis direction.

Referring to FIG. 3, the air conditioning device 100 may be installed to form or generate an air flow between indoors and outdoors. The air conditioning device 100 may be installed, e.g., at a boundary between indoors and outdoors. For example, the air conditioning device 100 may discharge the RA to the outside and supply the OA to the inside. For example, the air conditioning device 100 may circulate the RA. In order to circulate the RA, the air conditioning device 100 may suck and purify the RA and discharge it back indoors.

The air conditioning device 100 may include a main body 110. The main body 110 may form an outer appearance of the air conditioning device 100. The main body 110 may include at least one of a metal, plastic, carbon compound, or synthetic resin, or a combination of at least two thereof. The main body 110 may have a substantially hexahedral shape, but is not limited thereto, and may have various shapes. In the disclosure, it is assumed that the air conditioning device 100 has a hexahedral shape.

According to an embodiment of the disclosure, the main body 110 may include a first side 111 facing indoors and a second side 113 facing outdoors. A first intake port 121 through which the RA is introduced may be provided in the first side 111. The first side 111 may be provided with a first discharge port 127 through which air present in the air conditioning device 100 is discharged indoors. A second intake port 123 through which the OA is introduced may be provided in the second side 113. The second side 113 may be provided with a second discharge port 125 through which air present in the air conditioning device 100 is discharged outdoors.

According to an embodiment of the disclosure, the heat exchanger 140 may be provided inside the main body 110. The heat exchanger 140 may exchange energy of the RA introduced from indoors with energy of the OA introduced from outdoors. The heat exchanger 140 may be implemented as a total heat exchanger. The heat exchanger 140 may receive power from an external power source to reduce a temperature difference between the RA and the OA. Due to the heat exchanger 140, energy efficiency of the air conditioning device 100 may be increased.

According to an embodiment of the disclosure, a flow path according to at least one air flow may be formed inside the main body 110. For example, the at least one flow path may be formed as a pipe partitioned in a grid shape inside the heat exchanger 140. The at least one flow path may be formed of a porous pipe. The at least one flow path may be partitioned so that air may move in the intended direction inside the air conditioning device 100. Due to the at least one flow path provided inside the heat exchanger 140, air moving in different directions may move independently without being mixed (or joined). For example, the at least one flow path may include a first flow path for guiding the RA in a direction in which the RA is introduced and discharged outdoors. The at least one flow path may include a second flow path for guiding the OA in a direction in which the OA is introduced and supplied indoors.

According to an embodiment of the disclosure, the heat exchanger 140 may include at least one plate (141, 143, 145, and 147) forming an outer appearance thereof. The at least one plate (141, 143, 145, or 147) may include some or all of a first plate 141, a second plate 143, a third plate 145, or a fourth plate 147.

For example, the first plate 141 may be defined as a plate provided at a position where the RA passing through the first intake port 121 contacts (or touches) the heat exchanger 140.

For example, the second plate 143 may be defined as a plate provided at a position where the OA passing through the second intake port 123 contacts (or touches) the heat exchanger 140.

For example, the third plate 145 may be defined as a plate provided at a position where the air is discharged from the heat exchanger 140. The first plate 141 and the third plate 145 may face each other.

For example, the fourth plate 147 may be defined as a plate provided at a position where the air is discharged from the heat exchanger 140. The second plate 143 and the fourth plate 147 may face each other.

According to an embodiment of the disclosure, one edge of the first plate 141 may contact one edge of the second plate 143. The other edge of the second plate 143 may contact one edge of the third plate 145. The other edge of the third plate 145 may contact one edge of the fourth plate 147. The other edge of the fourth plate 147 may contact one edge of the first plate 141.

According to an embodiment of the disclosure, at least one partition wall 130 may be provided inside the main body 110. The at least one partition wall 130 may be provided to partition the inside of the main body 110 into a plurality of spaces. The plurality of spaces inside the main body 110 partitioned by the at least one partition wall 130 may be defined as compartments.

According to an embodiment of the disclosure, the at least one partition 130 may include a first partition 131, a second partition wall 133, a third partition 135, or a fourth partition 137.

For example, the first partition wall 131 may extend in a vertical direction (e.g., the +z-axis direction) from an edge where the ends of the first plate 141 and the second plate 143 contact (e.g., meet) each other on the upper side (e.g., upper half) of the main body 110.

For example, the second partition wall 133 may extend in the horizontal direction (e.g., the +x-axis direction) from an edge where the ends of the second plate 143 and the third plate 145 contact (e.g., meet) each other on the right side (e.g., right half) of the main body 110.

For example, the third partition wall 135 may extend in a vertical direction (e.g., the −z-axis direction) from an edge where the ends of the third plate 145 and the fourth plate 147 contact (e.g., meet) each other on the lower side (e.g., lower half) of the main body 110.

For example, the fourth partition wall 137 may extend in the horizontal direction (e.g., the −x-axis direction) from an edge where the ends of the fourth plate 147 and the first plate 141 contact (e.g., meet) each other on the left side (e.g., left half) of the main body 110.

According to an embodiment of the disclosure, the at least one partition wall 130 and the first to fourth plates 141, 143, 145, and 147 may form at least one compartment C1, C2, C3, and C4 inside the main body 110.

For example, the first compartment C1 may be formed as a space in which the main body 110 is partitioned by the first plate 141, the first partition wall 131, and the fourth partition wall 137.

For example, the second compartment C2 may be formed as a space in which the main body 110 is partitioned by the second plate 143, the first partition wall 131, and the second partition wall 133.

For example, the third compartment C3 may be formed as a space in which the main body 110 is partitioned by the third plate 145, the second partition wall 133, and the third partition wall 135.

For example, the fourth compartment C4 may be formed as a space in which the main body 110 is partitioned by the fourth plate 147, the third partition wall 135, and the fourth partition wall 137.

According to an embodiment of the disclosure, at least one filter (150 or 160) may be provided inside the main body 210. The at least one filter (150 or 160) may include a first filter 150 or a second filter 160. The first filter 150 and the second filter 160 may be implemented as separate filters or may be implemented as one filter.

For example, the first filter 150 may be implemented as a filter for adsorbing carbon dioxide. The first filter 150 may include a carbon dioxide adsorbent. The first filter 150 may have a surface coated with the carbon dioxide adsorbent, implemented in the form of pellets, or formed of the carbon dioxide adsorbent.

For example, the second filter 160 may be implemented as a filter for filtering harmful substances. The second filter 160 may include, e.g., a pre-filter or a high efficiency particulate air filter (HEPA filter). The second filter 160 may remove harmful substances, such as fine dust, harmful gases, radon, and hydrogen carbide, contained in the OA introduced into the air conditioning device 100.

For example, the carbon dioxide adsorbent may be configured by combining a carbon nanofiber material, a nanoparticle material, and a material containing an amine group at a predetermined component ratio. The carbon dioxide adsorbent may be formed by combining, e.g., a compound in which the nanoparticle material is bonded to a surface of the carbon nanofiber material using the carbon nanofiber material as a support, and the material containing the amine group to a surface of the compound. The carbon nanofiber material may include, e.g., CNT or GNF.

The nanoparticles may include, e.g., silicon dioxide (SiO₂), aluminum oxide (Al₂O₃), iron tetraoxide (Fe₃O₄), and titanium dioxide (TiO₂). It is possible to prepare a carbon dioxide adsorbent in the form of a compound by dispersing and bonding the nanoparticles using the carbon nanofiber material as a support by taking advantage of the fact that the nanoparticles have the property to agglomerate.

The material containing the amine group may include, e.g., polyethylenimine (PEI), aminopropyl triethoxysilane (3-aminopropyl triethoxysilane), tetraethylenepentamine (TEPA), or diethylenetriamine. Further, the material containing the amine group may include various materials including an amine group. The material containing the amine group may enable chemical adsorption as well as physical adsorption of the carbon dioxide adsorbent.

For example, carbon nanofibers and nanoparticle materials constituting the carbon dioxide adsorbent may be formed by varying their respective component proportions. The process of preparing the carbon dioxide adsorbent is as follows. For the carbon dioxide adsorbent, the carbon nanofiber and the nanoparticle material may be stirred for a predetermined time (e.g., three hours) and be subjected to ultrasonic treatment. Accordingly, dispersibility of nanoparticles bonded to the carbon nanofibers, which are supports constituting the carbon dioxide adsorbent, may be increased. The amine group may be bonded to the surface of the compound of the carbon nanofibers and the nanoparticles. The concentration of the amine group may meet, e.g., 40 to 60 wt %. The amine group may be bonded to the surface of the compound of the carbon nanofibers and the nanoparticles, and then dried in a vacuum oven at a predetermined temperature (e.g., 70° C.) for a predetermined time (e.g., 12 hours). The carbon dioxide adsorbent may be obtained by making the dried material into powder and drying it at a predetermined temperature (e.g., 70° C.) for a predetermined time (e.g., 12 hours).

According to an embodiment of the disclosure, carbon dioxide adsorption performance, oxidation, and volatility of the adsorbent may be determined according to the molecular weight of the amine group constituting the carbon dioxide adsorbent. For example, as the molecular weight of the amine group constituting the carbon dioxide adsorbent increases, the carbon dioxide adsorption performance may decrease, and oxidation and volatility of the gaseous material containing the amine group may increase. As the oxidation and volatility of the gaseous material containing the amine group increase, an unpleasant odor may be produced or generated depending on the type of amine gas desorbed from the carbon dioxide adsorbent. Due to these characteristics, the molecular weight of the amine group applied to the carbon dioxide adsorbent may be considered. For example, the molecular weight of the amine group may be considered in the range of 600 to 25,000.

For example, the carbon dioxide adsorbent may achieve a specific surface area of 500 m²/g. By achieving the specific surface area of the carbon dioxide adsorbent, the porous material may be replaced with a nanosilica material.

For example, the performance of the carbon dioxide adsorbent may be analyzed by thermogravimetric analysis. The performance of the carbon dioxide adsorbent may include carbon dioxide adsorption performance and carbon dioxide desorption (regeneration) performance. A method for analyzing the performance of the carbon dioxide adsorbent with the thermogravimetric analysis is as follows. The adsorption performance may expose the carbon dioxide adsorbent to carbon dioxide gas having a concentration level of 2000 ppm meeting a flow rate condition of 200 ml/min for about 60 minutes. The carbon dioxide adsorbent measured thereby may meet, e.g., a performance capable of adsorbing carbon dioxide of 1.5 mmol/g to 2.5 mmol/g and may prepare a carbon dioxide adsorbent with a goal of meeting a performance of 5.0 mmol/g according to conditions for the ratio of the components constituting the carbon dioxide adsorbent. The desorption performance may be measured by exposing nitrogen (N₂) gas having a temperature of about 70° C., a temperature increase rate of 10° C./min, and meeting a flow rate condition of 90 ml/min. The carbon dioxide adsorbent may maintain, e.g., 93% regeneration performance. The carbon dioxide adsorbent that has undergone a regeneration process may have, e.g., an adsorption property of 98% to 99%. The carbon dioxide adsorbent may be repeatedly used through a regeneration process.

According to an embodiment of the disclosure, the carbon dioxide adsorbent may be prepared through a phase inversion method. In preparing the carbon dioxide adsorbent, a polymer composite solution may be introduced into a solvent (e.g., an ethanol solution) in the form of a droplet. Accordingly, the carbon dioxide adsorbent may have a membrane or bead type rather than a powder type. The bead-type carbon dioxide adsorbent allows the adsorption component to be distributed at a high density, thereby enhancing adsorption performance even under low concentrations of carbon dioxide. The unit diameter of the bead-type adsorbent may meet, e.g., 3 mm. Through the preparation method, a bead-type adsorbent that may be usable without further processing the carbon dioxide adsorbent may be obtained.

According to an embodiment, the carbon dioxide adsorbent may be prepared by applying a polymer amine group to a synthetic resin-based adsorbent. For example, the obtained carbon dioxide adsorbent may include a synthetic resin-based adsorbent formed of polystyrene. Since the carbon dioxide adsorbent contains a hydrophobic polystyrene material, it may be less affected by moisture. The size of the carbon dioxide adsorbent may be identified with the naked eye, and the density is low, so that it may be easy to treat a material containing an amine group when preparing the carbon dioxide adsorbent. The carbon dioxide adsorbent may be prepared in the form of beads through encapsulation using a phase inversion method.

According to an embodiment of the disclosure, the carbon dioxide adsorbent may increase the selective adsorption performance of carbon dioxide gas and moisture resistance due to the material containing the amine group and nanoparticles. The carbon dioxide adsorbent may have different performance depending on the ratio of moisture contained in the air. Accordingly, as the moisture resistance of the carbon dioxide adsorbent increases, the performance of the carbon dioxide adsorbent may be enhanced.

According to an embodiment of the disclosure, since the carbon dioxide adsorbent is composed of carbon nanofibers and nanoparticles, a carbon dioxide adsorption filter may be prepared using materials harmless to the human body.

According to an embodiment of the disclosure, by applying a material containing an amine group to a carbon dioxide adsorbent, not only physical adsorption but also chemical adsorption may be possible, thereby enhancing carbon dioxide adsorption performance.

According to an embodiment of the disclosure, adsorption performance may be determined according to the type and component ratio of the carbon nanofibers, nanoparticles, and material containing the amine group constituting the carbon dioxide adsorbent. For example, the performance of the carbon dioxide adsorbent may meet 1.5 mmol/g to 2.5 mmol/g. However, the disclosure is not limited thereto, and higher performance may be met according to the type and component ratio of the materials constituting the carbon dioxide adsorbent. As the performance of the carbon dioxide adsorbent increases, cooling or heating energy required to reduce carbon dioxide present in the RA may be reduced.

According to an embodiment of the disclosure, the air conditioning device 100 may have different carbon dioxide adsorption performance depending on the size of the indoor space, the partitioned shape of the indoor space, or the number of occupants.

For example, the first filter 150 to which the carbon dioxide adsorbent having a performance of 1.3 mmol/g and a weight of 500 g is applied may reduce a carbon dioxide concentration level of 100 ppm for each of about five times in an apartment of 84 square meters (m³).

According to an embodiment of the disclosure, the first filter 150 may be provided at any point in a section in which the first air passage and the second air passage are common (e.g., shared). The first air passage may be defined as an air passage on a path through which the RA introduced through the first intake port 121 moves in the order of the first compartment C1, the third compartment C3, the second compartment C2, and the fourth compartment C4 and is discharged through the first discharge port 127. In other words, the first air passage may be a movement path of air that is the RA circulating inside the air conditioning device 100 and supplied as the SA. The second air passage may be defined as an air passage on a path through which the RA introduced through the first intake port 121 moves in the order of the first compartment C1 and the third compartment C3 and is discharged through the second discharge port 125. In other words, the second air passage may be a movement path of air that is the RA passing through the air conditioning device 100 and discharged as the EA. As the first filter 150 is provided at a point where the first air passage and the second air passage are common (or shared), the air conditioning device 100 may adsorb carbon dioxide in the RA.

For example, the first filter 150 may be provided or disposed at a point where the RA is sucked (e.g., flows or passes through). The first filter 150 may be provided to remove carbon dioxide contained in the RA before air is introduced into the heat exchanger 140. The first filter 150 may be provided on the first compartment C1. The first filter 150 may extend in a direction (e.g., the z-axis direction) perpendicular to a direction in which air is introduced through the first intake port 121. The first filter 150 may extend by the height of the first compartment C1 in the z-axis direction.

For example, the first filter 150 may be provided on the heat exchanger 140. The first filter 150 may be provided inside or on a surface of the heat exchanger 140. The first filter 150 may be provided, e.g., on the surface of the first plate 141 of the heat exchanger 140. The first filter 150 may be fixed to the surface of the first plate 141. In order for the first filter 150 to be fixed to the surface of the first plate 141, a guide member (not shown) for fixing the first filter 150 to the surface of the first plate 141 may be provided. The guide member may be integrally formed with the first plate 141 or may be bolted or adhered to the first plate 141. For example, a groove as deep as the first filter 150 may be formed in the guide member. The first filter 150 may be fitted into the guide member. With the guide member is provided on the surface of the first plate 141, the first filter 150 may be replaced more easily. The first filter 150 may be fixed to the heat exchanger 140 by screwing (or fasten by twisting). Although not shown, the first filter 150 may be provided on the surface of the third plate 145 of the heat exchanger 140. If the first filter 150 is implemented as a plurality of filters, the first filter 150 may be provided on each of the surfaces of the first plate 141 and the third plate 145.

According to an embodiment, the second filter 160 may be provided at a point where the third air passages are common (or shared). The third air passage may be defined as an air passage on a path through which the OA introduced through the second intake port 123 moves in the order of the second compartment C2 and the fourth compartment C4 and is discharged through the first discharge port 127. In other words, the third air passage may be a movement path of air through which the OA passes through the air conditioning device 100 and is discharged as the SA. As the second filter 160 is provided on the third air passage, the air conditioning device 100 may remove harmful substances from the OA.

For example, the second filter 160 may be provided on the heat exchanger 140. The second filter 160 may be provided inside or on a surface of the heat exchanger 140. The second filter 160 may be provided, e.g., on the surface of the second plate 143 of the heat exchanger 140. The second filter 160 may be fixed to the surface of the second plate 143. In order fix the second filter 160 to the surface of the second plate 143, a guide member (not shown) may be provided. The guide member may be integrally formed with the second plate 143 or may be bolted or adhered to the second plate 143. For example, a groove as deep as the second filter 160 may be formed in the guide member. The second filter 160 may be fitted into the guide member. Since the guide member is provided on the surface of the second plate 143, the second filter 160 may be conveniently replaced. The second filter 160 may be fixed to the heat exchanger 140 by screwing (or fasten by twisting). Although not shown, the second filter 160 may be provided on the surface of the fourth plate 147 of the heat exchanger 140. If the second filter 160 is implemented as a plurality of filters, the second filter 160 may be provided on each of the surfaces of the second plate 143 and the fourth plate 147.

For example, the second filter 160 may be provided at a point where the OA is sucked (e.g., flows or passes through). The second filter 150, e.g., may be provided at any point on the second intake port 123 to filter impurities contained in the OA. The second filter 150 may be disposed perpendicular to a path through which air is introduced into the second intake port 123.

For example, the second filter 160 may be provided at a point where the SA is discharged. The second filter 160, e.g., may be provided at any point on the first discharge port 127 to filter impurities contained in the SA to be supplied indoors. The second filter 150 may be disposed perpendicular to a path through which air is introduced into the first discharge port 127.

According to an embodiment, the first filter 150 and the second filter 160 may be provided together at the same position. For example, the first filter 150 and the second filter 160 may be positioned on the first plate 141.

According to an embodiment, the first filter 150 and the second filter 160 may be configured as one (or a single) filter. If the first filter 150 and the second filter 160 are configured as one filter, the filter may be provided in a space (e.g., the first compartment C1) in which the RA is sucked (e.g., flows or passes through). The filter may extend in a direction (e.g., the z-axis direction) perpendicular to the direction in which the RA is sucked (e.g., flows or passes through).

According to an embodiment, at least one dampers (121a, 123a, 125a, 127a, 131a, 133a, 135a, 137a, or 139a) (e.g., the damper 230 of FIG. 2) may be provided in the air conditioning device 100. The at least one damper (121a, 123a, 125a, 127a, 131a, 133a, 135a, 137a, or 139a) may be provided to open or close a passage for air entering and exiting the air conditioning device 100 or air circulating in the air conditioning device 100. The at least one damper (121a, 123a, 125a, 127a, 131a, 133a, 135a, 137a, or 139a) may be opened or closed by a controller (e.g., the controller 110 of FIG. 2).

According to an embodiment, the at least one damper (121a, 123a, 125a, 127a, 131a, 133a, 135a, 137a, and 139a) may include a first damper 121a, a second damper 123a, a third damper 125a, a fourth damper 127a, a fifth damper 131a, a sixth damper 133a, a seventh damper 135a, an eighth damper 137a, or a ninth damper 139a. Although not shown, the at least one damper (121a, 123a, 125a, 127a, 131a, 133a, 135a, 137a, or 139a) may further include more dampers as needed.

For example, the first damper 121a may be provided in the first intake port 121. The first damper 121a may open or close the first intake port 121 through which the RA is introduced.

For example, the second damper 123a may be provided in the second intake port 123. The second damper 123a may open or close the second intake port 123 through which the OA is introduced.

For example, the third damper 125a may be provided in the second discharge port 125. The third damper 125a may open or close the second discharge port 125 discharged as the exhaust air.

For example, the fourth damper 127a may be provided in the first discharge port 127. The fourth damper 127a may open or close the first discharge port 127 supplied as the SA.

For example, the fifth damper 131a may be provided on the first partition wall 131. The fifth damper 131a may open or close an air passage between the first compartment C1 and the second compartment C2.

For example, the sixth damper 133a may be provided on the second partition wall 133. The sixth damper 133a may open or close an air passage between the second compartment C2 and the third compartment C3.

For example, the seventh damper 135a may be provided on the third partition wall 135. The seventh damper 135a may open or close an air passage between the third compartment C3 and the fourth compartment C4.

For example, the eighth damper 137a may be provided on the fourth partition wall 137. The eighth damper 137a may open or close an air passage between the fourth compartment C4 and the first compartment C1.

For example, the ninth damper 139a may be provided on an upper surface of the main body 110. The ninth damper 139 may be provided at a point spaced apart from the power supply 180 by a predetermined distance in the +y-axis direction. The ninth damper 139a may open or close the passage so that air in the first compartment C1 may be discharged outdoors without passing through the heat exchanger 140. As the ninth damper 139a is provided in the air conditioning device 100, a bypass path for discharging RA outdoors may be formed.

According to an embodiment, the main body 110 may further include a separate discharge port (not shown) for discharging air discharged to the ninth damper 139a outdoors (e.g., to the outside). The discharge port may be defined as a third discharge port. The third discharge port may be provided with a passage for fluid communication between the first compartment C1 and the outside. For example, the third discharge port may be provided with a damper that may be opened or closed to allow air to move outdoors. By opening or closing the damper provided in the third discharge port, the air conditioning device 100 may allow air staying in the first compartment C1 to bypass the passage from the first compartment C1 and be discharged outdoors.

According to an embodiment of the disclosure, as the at least one damper (121a, 123a, 125a, 127a, 131a, 133a, 135a, 137a, or 139a) is opened or closed, an air passage may be formed.

For example, if the first damper 121a, the fourth damper 127a, and the sixth damper 133a are opened and the remaining dampers (123a, 125a, 131a, 135a, 137a, and 139a) are closed, the RA is introduced into the air conditioning device 100 through the first intake port 121, moves to the first compartment C1, the third compartment C4, the second compartment C2, and the fourth compartment C4 in order, and then is supplied indoors through the first discharge port 127. In other words, the air may move along the first air passage.

For example, if the first damper 121a and the third damper 125a are opened and the remaining dampers (123a, 127a, 131a, 133a, 135a, 137a, and 139a) are closed, the RA is introduced into the air conditioning device 100 through the first intake port 121, moves to the first compartment C1 and the third compartment C3 in order, and then is discharged outdoors (e.g., to the outside) through the second discharge port 125. In other words, the air may move along the second air passage.

For example, if the second damper 123a and the fourth damper 127a are opened and the remaining dampers (121a, 125a, 131a, 133a, 135a, 137a, and 139a) are closed, the OA is introduced into the air conditioning device 100 through the second intake port 123, moves to the second compartment C2 and the fourth compartment C4 in order, and then is supplied indoors through the first discharge port 127. In other words, the air may move along the third air passage.

For example, if the first damper 121a, the third damper 125a, the fifth damper 131a, and the sixth damper 133a are opened and the remaining dampers (123a, 127a, 135a, 137a, and 139a) are closed, the RA is introduced into the air conditioning device 100 through the first intake port 121, moves to the first compartment C1, the second compartment C2, and the third compartment C3 in order without passing through the heat exchanger 140, and then is discharged outdoors (e.g., to the outside) through the second discharge port 125. In other words, the air may move along the fourth air passage.

For example, if the first damper 121a and the ninth damper 139a are opened and the remaining dampers (123a, 125a, 127a, 131a, 133a, 135a, and 137a) are closed, the RA is introduced into the air conditioning device 100 through the first intake port 121 and discharged outdoors (e.g., to the outside) from the first compartment C1 without passing through the heat exchanger 140. In other words, the air may move along the fifth air passage.

According to an embodiment, the air conditioning device 100 may further include a damper in addition to at least one damper (121a, 123a, 125a, 127a, 131a, 133a, 135a, 137a, or 139a). Although not illustrated, the at least one damper (121a, 123a, 125a, 127a, 131a, 133a, 135a, 137a, or 139a) may include a damper for opening or closing the third discharge port connected to the ninth damper 139a. The damper may be provided on the third discharge port to discharge air present in the first compartment C1 outdoors. The air conditioning device 100 may open or close the damper provided in the third discharge port.

According to an embodiment, the at least one blower 171 or 173 (e.g., the blower 240 of FIG. 2) may be provided to control the air in the air conditioning device 100 to move in an arbitrary direction. The at least one blower (171 or 173) may accelerate the moving speed of air in the air conditioning device 100. The at least one blower (171 or 173) may be positioned adjacent to an intake port (e.g., the first intake port 121 or the second intake port 123) or a discharge port (e.g., the first discharge port 127 or the second discharge port 125) but is not limited thereto. The at least one blower (171 or 173) may include a first blower 171 or a second blower 173.

For example, the first blower 171 may be provided near the first discharge port 127. The first blower 171 may supply or provide air in the fourth compartment C4 indoors.

For example, the second blower 173 may be provided near the second discharge port 125. The second blower 173 may discharge air in the third compartment C3 outdoors.

Although not shown, the air conditioning device 100 may further include a blower in addition to the first blower 171 or the second blower 173. The blower may be provided, e.g., near the first intake port 121 to accelerate (or speed up) the RA to be introduced into the air conditioning device 100. The blower may be provided, e.g., near the second intake port 123 to accelerate the OA to be introduced into the air conditioning device 100 more quickly. The blower may be provided, e.g., near the ninth damper 139a to quickly discharge air present in the first compartment C1 to the outside.

According to an embodiment, the air conditioning device 100 may include a heater (not shown) (e.g., the heater 251 of FIG. 2). The heater may be provided to heat the first filter 150 to a predetermined temperature. The predetermined temperature may be, e.g., 65° C. to 70° C. If the first filter 150 is heated to the predetermined temperature, carbon dioxide adsorbed to the first filter 150 may be separated. Accordingly, the regenerated first filter 150 may adsorb carbon dioxide again by the adsorption capacity.

According to an embodiment, the heater may be provided near the first filter 150. The heater may be implemented in the form of a heating wire. The heating wire may be composed of a conducting wire having a predetermined resistance value. The heater may be heated to a predetermined temperature by an external power source. In addition to those shown, the heater may be implemented in various forms. For example, the heater may be implemented in the form of a hot air fan that discharges air of a predetermined temperature to the first filter 150.

According to an embodiment, the air conditioning device 100 may include at least one sensor (not shown) (e.g., the sensor 220 of FIG. 2). The at least one sensor may include a gas sensor.

For example, the gas sensor may detect the concentration of a specific gas (e.g., carbon dioxide). The gas sensor may detect the concentration of carbon dioxide in the RA or may detect the concentration of carbon dioxide adsorbed to the first filter 150. The gas sensor may transmit information about the detected carbon dioxide concentration to a control unit (e.g., the controller 210 of FIG. 2).

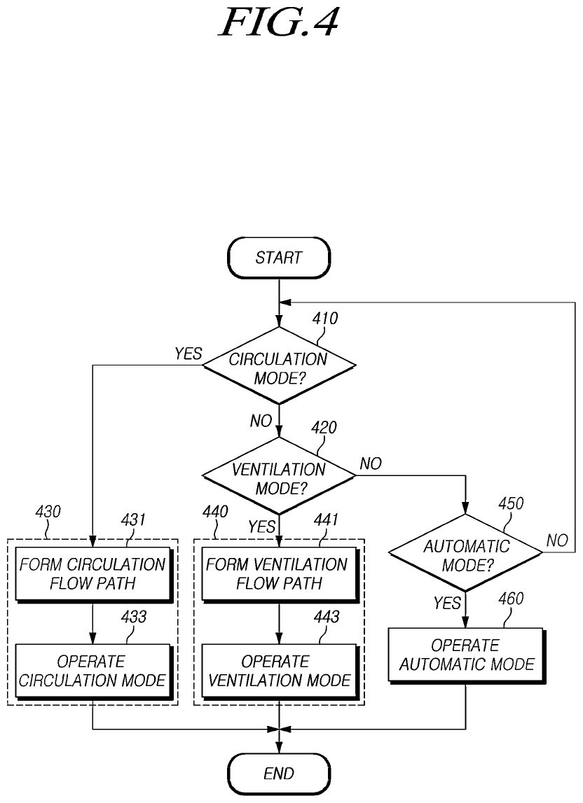

FIG. 4 is a flowchart illustrating an example control for selecting an operation type of an air conditioning device 100 (e.g., the air conditioning device 100 of FIG. 1) according to an embodiment of the disclosure. In the following control flowchart, each operation is not limited to that illustrated, and the same operation may be repeated, the order may be different, or several operations may be operated simultaneously.

Referring to FIG. 4, an operation type on the air conditioning device 100 may be selected based on the user's input or manipulation. If there is no user's input or manipulation, an operation type on the air conditioning device 100 may be selected based on a preset condition.

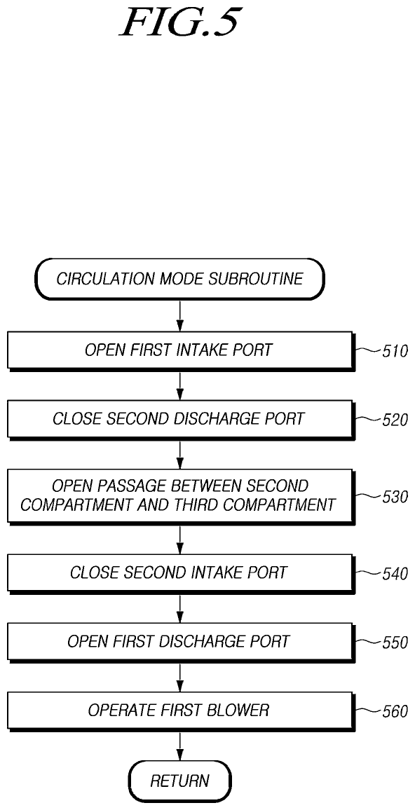

According to an embodiment, in operation 410, the air conditioning device 100 may determine or identify whether the air conditioning device 100 is in the circulation mode. The air conditioning device 100 may determine whether the circulation mode is selected by the user's input or manipulation. In the circulation mode, in operation 430, the air conditioning device 100 may execute a subroutine for performing the circulation operation based on the circulation mode. The air conditioning device 100 may form a circulation flow path in operation 431 to execute a subroutine for operating in the circulation mode. The air conditioning device 100 may operate in the circulation mode in operation 433. A control flowchart of the subroutine for operating in the cyclic mode is described in detail below with reference to FIG. 5.

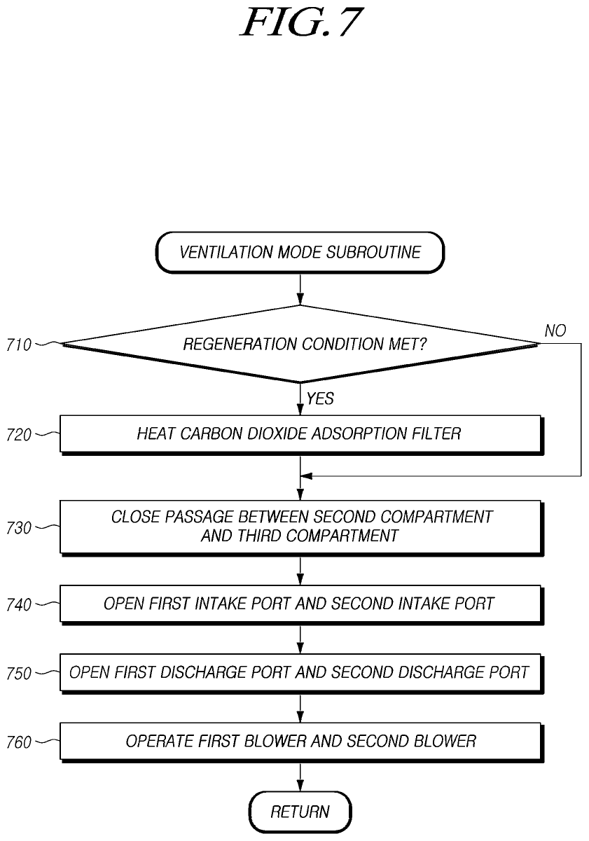

According to an embodiment, in operation 420, the air conditioning device 100 may determine or identify whether the air conditioning device 100 is in the ventilation mode. The air conditioning device 100 may determine whether the ventilation mode is selected by the user's input or manipulation. In the ventilation mode, in operation 440, the air conditioning device 100 may execute a subroutine for performing the ventilation operation based on the ventilation mode. In operation 441, the air conditioning device 100 may form a ventilation flow path to execute a subroutine for operating in the ventilation mode. The air conditioning device 100 may operate in the ventilation mode in operation 443. A control flowchart of the subroutine for operating in the ventilation mode is described in detail with reference to FIG. 7.

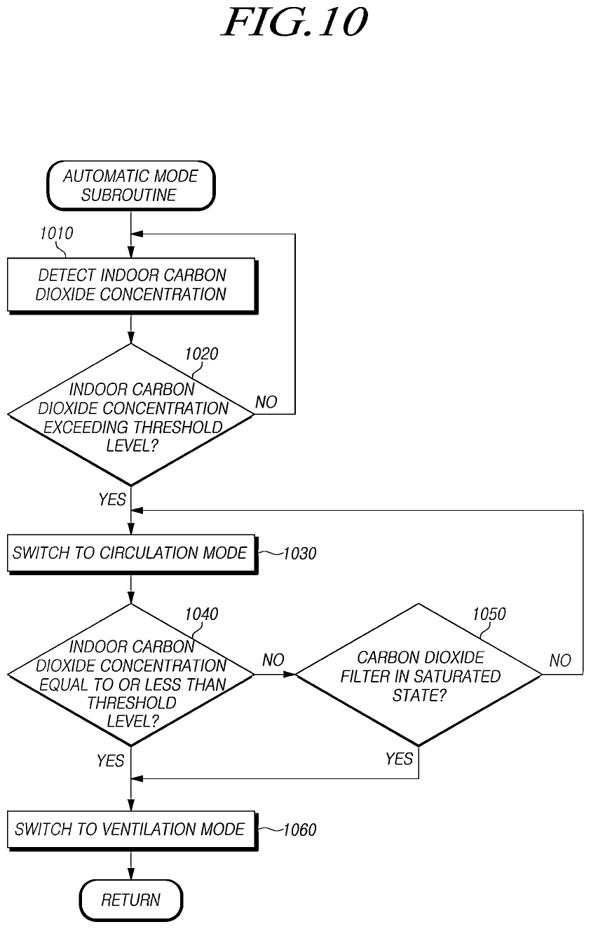

According to an embodiment, if the air conditioning device 100 is neither in the ventilation mode nor in the circulation mode, the air conditioning device 100 may determine or identify whether the air conditioning device 100 is in the automatic mode in operation 450. The air conditioning device 100 may determine whether there is no mode selected by the user by operating in the ventilation mode or the circulation mode, or whether the automatic mode is selected by the user's manipulation. In the automatic mode, in operation 460, the air conditioning device 100 may execute a subroutine for operating in the automatic mode. A control flowchart of the subroutine for operating in the automatic mode is described below in detail with reference to FIG. 10.

FIG. 5 is a flowchart illustrating an example subroutine for a circulation operation (e.g., operation 430 of FIG. 4) in an air conditioning device 100 (e.g., the air conditioning device 100 of FIG. 1) according to an embodiment. At least one of the dampers (e.g., the first to ninth dampers 121a, 123a, 125a, 127a, 131a, 133a, 135a, 137a, or 139a of FIG. 3) not mentioned as being opened or closed in the flowchart of FIG. 5 or its subsequent figures may be understood as being in the closed state.

Referring to FIG. 5, in operation 510, the air conditioning device 100 may open a first intake port (e.g., the first intake port 121 of FIG. 3). In order to open the first intake port 121, the air conditioning device 100 may control to open a first damper (e.g., the first damper 121a of FIG. 3) provided near the first intake port 121. If the first intake port 121 is opened, RA may be introduced into the air conditioning device 100. Carbon dioxide gas, having a predetermined concentration level or higher, may be in the RA.

According to an embodiment, in operation 520, the air conditioning device 100 may close the second discharge port (e.g., the second discharge port 125 of FIG. 3). In order to close the second discharge port 125, the air conditioning device 100 may control a third damper (e.g., the third damper 125a of FIG. 3) provided near the second discharge port 125 to be closed. If the first discharge port 127 is closed, the air in (or inside) the air conditioning device 100 (e.g., the third compartment C3) may be prevented from being discharged outdoors.

According to an embodiment, in operation 530, the air conditioning device 100 may open a passage between the second compartment (e.g., the second compartment C2 of FIG. 3) and the third compartment (e.g., the third compartment C3 of FIG. 3). In order to open the passage, the air conditioning device 100 may open a sixth damper (e.g., the sixth damper 133a of FIG. 3) provided on the second partition (e.g., the second partition wall 133 of FIG. 3). If the passage is opened, the air in (or inside) the third compartment C3 may be guided to the second compartment C2.

According to an embodiment, in operation 540, the air conditioning device 100 may close the second intake port (e.g., the second intake port 123 of FIG. 3). In order to close the second intake port 123, the air conditioning device 100 may control to close a second damper (e.g., the second damper 123a of FIG. 3) provided near the second intake port 123. If the second intake port 123 is closed, the air inside the air conditioning device 100 (e.g., the second compartment C2) may be prevented from being discharged outdoors (e.g., to the outside).

According to an embodiment, in operation 550, the air conditioning device 100 may open the first discharge port (e.g., the discharge port 127 of FIG. 3). In order to open the first discharge port 127, the air conditioning device 100 may open a fourth damper (e.g., the fourth damper 127a of FIG. 3) provided near the first discharge port 127. If the first discharge port 127 is opened, the air in or inside the air conditioning device 100 may be supplied indoors.

According to an embodiment, in operation 560, the air conditioning device 100 may operate a first blower (e.g., the first blower 171 of FIG. 3). If the first blower 171 is operated, supply indoors of the air inside the air conditioning device 100 may be accelerated.

According to an embodiment, the illustrated operations are not limited to the illustrated order and may be changed in order or may operate simultaneously. The above-described operations may be repeatedly performed.

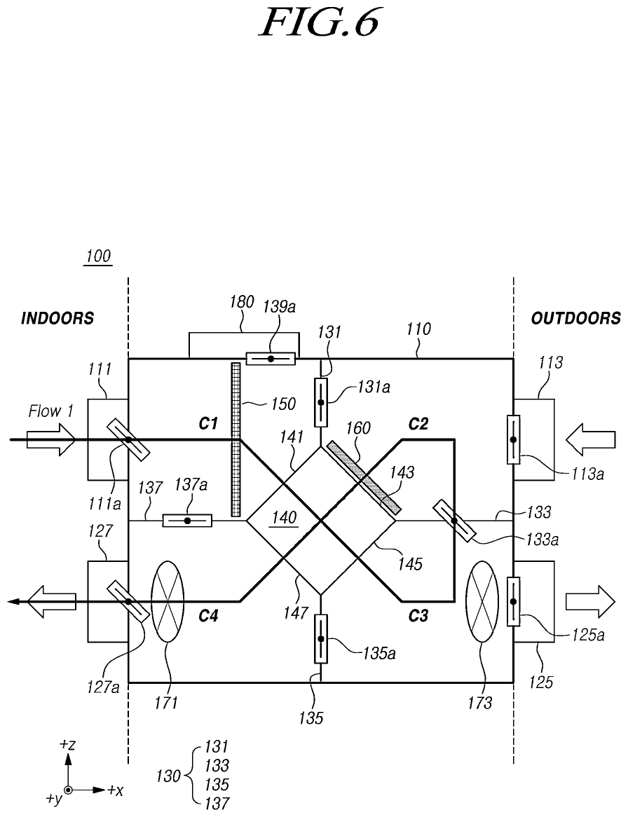

FIG. 6 illustrates an example air flow Flow 1 during a circulation operation (e.g., the circulation mode of FIG. 4) in an air conditioning device (e.g., the air conditioning device 100 of FIG. 1) according to an embodiment.

Referring to FIG. 6, as the first intake port 121 is opened, RA may be introduced into the air conditioning device 100. The introduced air may move from the first compartment C1 to the third compartment C3.

According to an embodiment of the disclosure, the air introduced into the air conditioning device 100 may pass through the first filter 150 provided in the first compartment C1 before reaching the third compartment C3. The air may pass through the first filter 150 and carbon dioxide in the air may be adsorbed to the first filter 150. The air passing through the first filter 150 may have a lower carbon dioxide concentration level than that of the RA. As the second discharge port 125 is closed, the air may not be discharged outdoors.

According to an embodiment, the air staying in the third compartment C3 may move (or flow) from the third compartment C3 to the second compartment C2 as the sixth damper 133a is opened. As the second intake port 123 is closed, the OA may not be introduced into the air conditioning device 100 (e.g., the second compartment C2).

According to an embodiment, the air in or inside the second compartment C2 may move or flow to the fourth compartment C4. Before the air reaches the fourth compartment C4, the air may pass through the second filter 160 provided in the heat exchanger 140. The air may pass through the second filter 160, and harmful substances contained in the air may be adsorbed by or at the second filter 160. The air passing through the second filter 160 may have a lower carbon dioxide concentration level and a lower concentration of harmful substances than that of the RA.

According to an embodiment, as the first discharge port 127 is opened, the air in or inside the fourth compartment C4 may be supplied indoors. As the first blower 171 is operated, the amount of gas per hour supplied indoors (e.g., to the inside) may increase.

According to an embodiment, the SA provided indoors according to the circulation mode may have a lower carbon dioxide concentration level and a lower concentration of harmful substances than that of the RA.

According to an embodiment, the air conditioning device 100 may repeatedly operate the circulation mode for a predetermined time to remove (or reduce) carbon dioxide and harmful substances in the RA below a predetermined level.

According to an embodiment, the air conditioning device 100 may minimize the operation of the heat exchanger 140 while the circulation mode is operated, thereby saving electrical energy required to operate the heat exchanger 140.

According to an embodiment, the air conditioning device 100 may reduce energy required for cooling and heating by purifying the RA through the first filter 150 or the second filter 160 without exchanging with the OA through the circulation mode.

FIG. 7 is a flowchart illustrating an example subroutine for a ventilation operation (e.g., the ventilation mode of FIG. 4) in an air conditioning device 100 (e.g., the air conditioning device 100 of FIG. 1) according to an embodiment.

Referring to FIG. 7, in operation 710, the air conditioning device 100 may determine whether a condition for regenerating a first filter (e.g., the first filter 150 of FIG. 3) is met. For example, the condition for regenerating the first filter 150 may be a case in which the concentration level of carbon dioxide adsorbed to the first filter 150 exceeds a threshold capacity of the first filter 150 or the concentration level of carbon dioxide in the RA is less than or equal to a threshold concentration level. The threshold capacity of the first filter 150 may be, e.g., 1200 ppm. The threshold concentration level of carbon dioxide in the RA may be, e.g., 1000 ppm.

According to an embodiment, if it is determined that the regeneration condition is met by the air conditioning device 100, in operation 720, the first filter 150 may be heated to a predetermined temperature to desorb carbon dioxide adsorbed to the first filter 150. The air conditioning device 100 may operate a heater (e.g., the heater 251 of FIG. 2) to heat the first filter 150 to a predetermined temperature. The predetermined temperature may be, e.g., 65° C. to 70° C.

As described above, if the amount of carbon dioxide adsorbed by the first filter 150 exceeds an adsorption volume, the carbon dioxide adsorbed by the first filter 150 may be removed and reused by a method of heating the first filter 150 to increase filter regeneration efficiency. Therefore, it is possible to effectively remove continuously generated carbon dioxide and increase energy efficiency.

According to an embodiment, in operation 730, the air conditioning device 100 may close the passage between the second compartment (e.g., the second compartment C2 of FIG. 3) and the third compartment (e.g., the third compartment C3 of FIG. 3). In order to close the passage, the air conditioning device 100 may close a sixth damper (e.g., the sixth damper 133a of FIG. 3) provided on the second partition (e.g., the second partition wall 133 of FIG. 3). If the passage is closed, the air in or inside the second compartment C2 and the air in or inside the third compartment C3 may be divided.

According to an embodiment, in operation 740, the air conditioning device 100 may open the first intake port (e.g., the first intake port 121 of FIG. 3) and the second intake port (e.g., the second intake port 123 of FIG. 3). In order to open the first intake port 121, the air conditioning device 100 may open a first damper (e.g., the first damper 121a of FIG. 3) provided near the first intake port 121. In order to open the second intake port 123, the air conditioning device 100 may open a second damper (e.g., the second damper 123a of FIG. 3) provided near the second intake port 123. If the first intake port 121 is opened, the RA may be introduced into the air conditioning device 100. If the second intake port 123 is opened, the OA may be introduced into the air conditioning device 100.

According to an embodiment, the RA introduced into the air conditioning device 100 through the first intake port 121 may pass through the first filter 150 provided in the first compartment C1 before passing through the first compartment C1 and reaching the third compartment C3. The first filter 150 may adsorb carbon dioxide contained in the introduced the RA. The air passing through the first filter 150 and in the third compartment C3 may contain a smaller concentration level of carbon dioxide than that of the RA.

According to an embodiment, the OA introduced into the air conditioning device 100 through the second intake port 123 may pass through the second filter 160 provided in the heat exchanger 140 before passing through the second compartment C2 and reaching the fourth compartment C4. The second filter 160 may adsorb harmful substances contained in the introduced the RA. The air passing through the first filter 150 and in the third compartment C3 may include harmful substances having a smaller concentration level than that of the RA.

According to an embodiment, in operation 750, the air conditioning device 100 may open the first discharge port (e.g., the first discharge port 127 of FIG. 3) and the second discharge port (e.g., the second discharge port 125 of FIG. 3). In order to open the first discharge port 127, the air conditioning device 100 may open a fourth damper (e.g., the fourth damper 127a of FIG. 3) provided near the first discharge port 127. In order to open the second discharge port 125, the air conditioning device 100 may open a third damper (e.g., the third damper 125a of FIG. 3) provided near the second discharge port 125. If the first discharge port 127 is opened, the SA may be supplied (or discharged) to the outside of the air conditioning device 100. If the second discharge port 125 is opened, the EA may be discharged to the outside of the air conditioning device 100.

According to an embodiment, in operation 760, the air conditioning device 100 may operate a first blower (e.g., the first blower 171 of FIG. 3) and a second blower (e.g., the second blower 173 of FIG. 3). If the first blower 171 is operated, the air supplied or provided to the inside of the air conditioning device 100 may be accelerated. If the second blower 173 is operated, the air discharged or directed to the outside of the air conditioning device 100 may be accelerated.

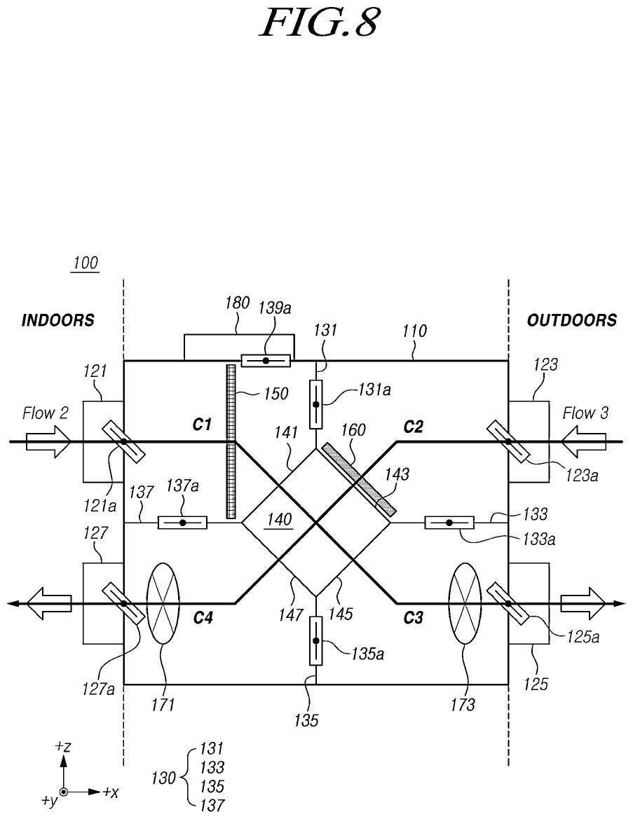

FIG. 8 illustrates example air flows Flow 2 and Flow 3 during a ventilation operation (e.g., the ventilation mode of FIG. 4) in the air conditioning device 100 (e.g., the air conditioning device 100 of FIG. 1) according to an embodiment.

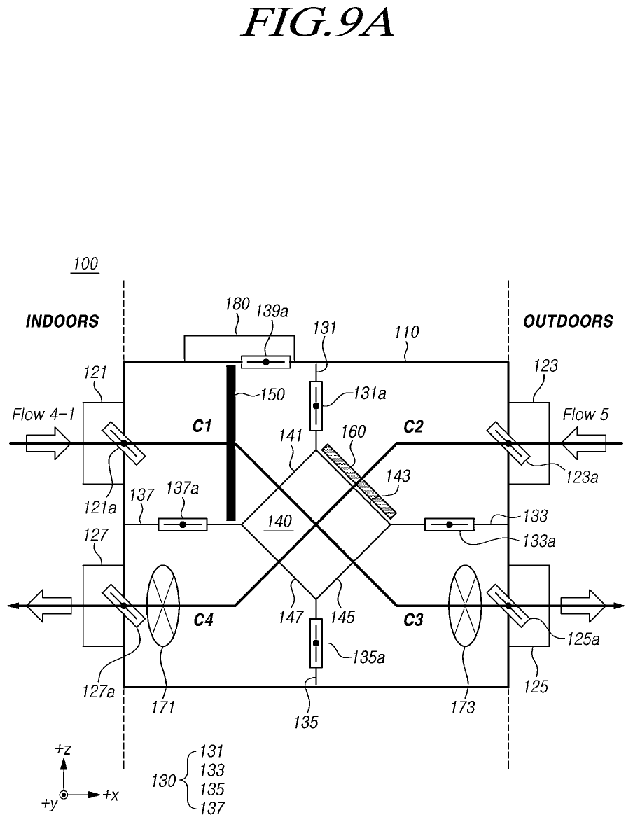

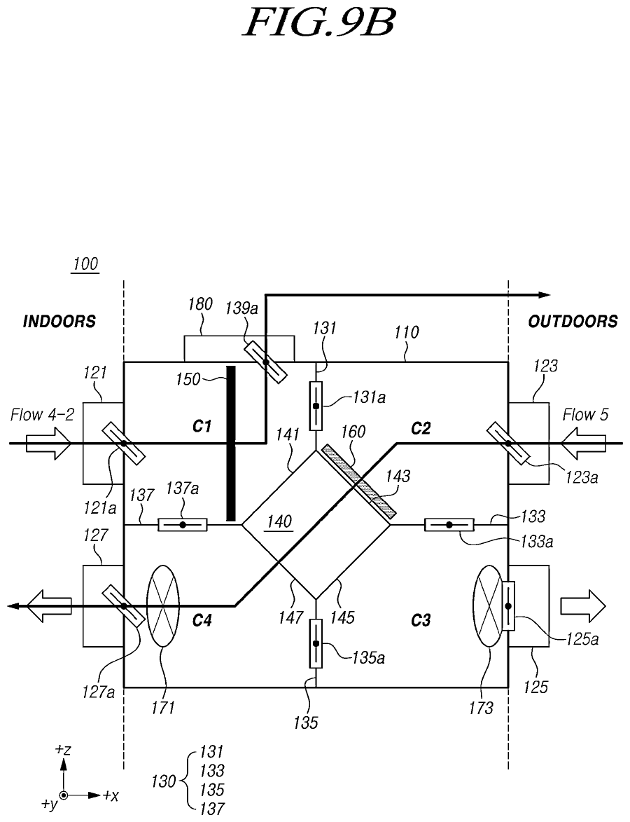

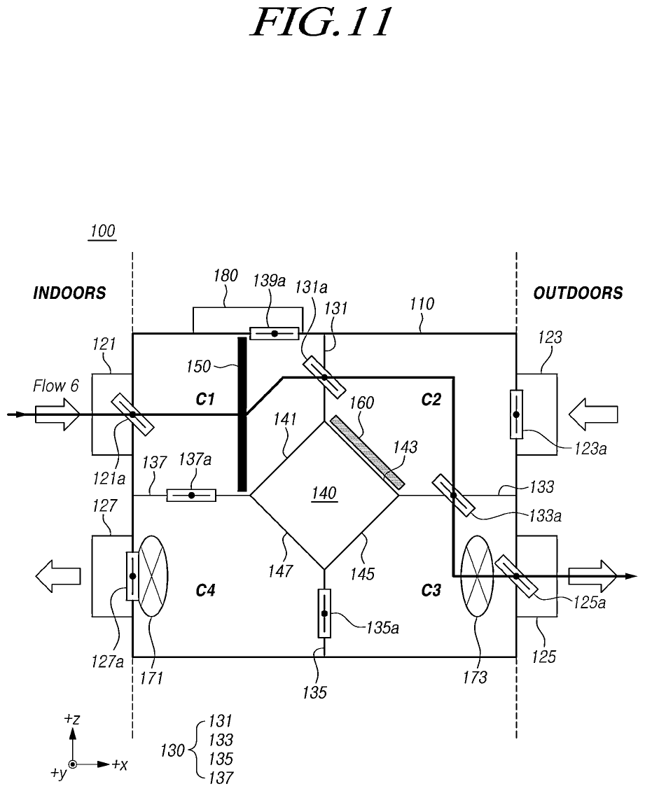

Referring to FIG. 8, compared to FIGS. 9A, 9B, and 11, an operation for discharging RA outdoors and supplying the OA indoors, without heating the first filter 150, is performed. In other words, it may be understood as a description of an operation in which the air conditioning device 100 ventilates without removing carbon dioxide adsorbed to the first filter 150 by, e.g., a method of heating the first filter 150.

According to an embodiment, as the first intake port 121 is opened, the RA may be introduced into the air conditioning device 100. The introduced air may move from the first compartment C1 to the third compartment C3.

According to an embodiment, the air introduced into the air conditioning device 100 may pass through the first filter 150 provided in the first compartment C1 before reaching the third compartment C3. The air may pass through the first filter 150 and carbon dioxide in the air may be adsorbed to the first filter 150. The air passing through the first filter 150 may have a lower carbon dioxide concentration level than that of the indoor air.

According to an embodiment, the air passing through the first filter 150 and reaching the third compartment C3 may be discharged as the EA through the second discharge port 125. The EA may have a lower carbon dioxide concentration level than that of the RA.

According to an embodiment, as the second intake port 123 is opened, the OA may be introduced into the air conditioning device 100. The introduced air may move from the second compartment C2 to the fourth compartment C4.

According to an embodiment, the air introduced into the air conditioning device 100 may pass through the second filter 160 provided in the heat exchanger 140 before reaching the fourth compartment C4. The air may pass through the second filter 160, and harmful substances in the air may be adsorbed to the second filter 160. The air passing through the second filter 160 may have a lower concentration level of harmful substances than that of the OA.

According to an embodiment, the air passing through the second filter 160 and reaching the fourth compartment C4 may be supplied as the SA through the first discharge port 127. The SA may have a lower concentration level of harmful substances than that of the OA.

According to an embodiment, the air conditioning device 100 may ventilate the RA by exchanging the RA and the OA. The air conditioning device 100 may increase energy efficiency by minimizing a difference in thermal energy between the RA and the OA through the heat exchanger 140. The air conditioning device 100 may reduce carbon dioxide discharged outdoors by adsorbing carbon dioxide in the RA through the first filter 150.

FIG. 9A illustrates an example air flow for removing carbon dioxide adsorbed to a filter during a ventilation operation in an air conditioning device 100 (e.g., the air conditioning device 100 of FIG. 1) according to an embodiment of the disclosure.

Referring to FIG. 9A, all or part of the airflows may correspond to those of FIG. 8. However, it differs from FIG. 8 in that the operation of FIG. 9A removes carbon dioxide adsorbed to the first filter 150 by heating the first filter 150 if the air conditioning device 100 performs a ventilation operation. Therefore, redundant descriptions will be omitted, and differences will be mainly described.

According to an embodiment, the air conditioning device 100 may heat the first filter 150 to a predetermined temperature to desorb carbon dioxide adsorbed to the first filter 150. The air conditioning device 100 may heat the first filter 150 by operating a heater (e.g., the heater unit 251 of FIG. 2). The predetermined temperature may be, e.g., 65° C. to 70° C. If the air conditioning device 100 heats the first filter 150 to a predetermined temperature, carbon dioxide adsorbed to the first filter 150 may be desorbed.

According to an embodiment, the air conditioning device 100 may regenerate the first filter 150 by desorbing carbon dioxide adsorbed to the first filter 150. The regeneration performance of the regenerated first filter 150 may be maintained at 93%. The adsorption performance of the regenerated first filter 150 may be maintained at 98% to 99% compared to the performance before being regenerated.

According to an embodiment, the air conditioning device 100 may discharge carbon dioxide desorbed from the first filter 150 through the second discharge port 125.

For example, the air conditioning device 100 may open the first damper 121a provided in the first intake port 121 and may open the third damper 125a provided in the second discharge port 125. The air conditioning device 100 may operate the second blower 173.

According to an embodiment, the air conditioning device 100 may introduce (e.g., intake) the OA into the air conditioning device 100 and supply (e.g., discharge) the air, as the SA, indoors (e.g., to the inside).

For example, the air conditioning device 100 may open the second damper 123a provided in the second intake port 123 and may open the fourth damper 127a provided in the first discharge port 127. The air conditioning device 100 may operate the first blower 171.

According to an embodiment, the air conditioning device 100 may discharge carbon dioxide, adsorbed to the first filter 150, outdoors (e.g., to the outside), purify the OA with the second filter 160, and supply the purified OA as the SA. The air conditioning device 100 may reduce the cooling and heating load by minimizing the thermal energy difference between the RA and the OA through the heat exchanger 140.

According to an embodiment, the air conditioning device 100 may simultaneously perform ventilation and regeneration of the first filter 150. The air conditioning device 100 may achieve energy reduction by minimizing a heating load that may occur in the winter.

For example, if the air conditioning device 100 performs a ventilation operation in the winter, if the first filter 150 is heated to desorb carbon dioxide adsorbed to the first filter 150, the air passing through the first filter 150 may be heated to a predetermined temperature (e.g., 65° C. to 70° C.). If the air heated to the predetermined temperature is discharged outdoors through the heat exchanger 140 by the proposed air path Flow 4-1, the OA may be supplied indoors through the heat exchanger 140, and the OA may be heated in the heat exchanger 140. Accordingly, the temperature of the RA may increase, and thus energy required for heating may be reduced.

FIG. 9B illustrates an example air flow for removing carbon dioxide adsorbed to a filter during a ventilation operation in an air conditioning device 100 (e.g., the air conditioning device 100 of FIG. 1) according to an embodiment of the disclosure.

Referring to FIG. 9B, the air conditioning device 100 may heat the first filter 150 to a predetermined temperature to desorb carbon dioxide adsorbed to the first filter 150. The air conditioning device 100 may heat the first filter 150 by operating a heater (e.g., the heater unit 251 of FIG. 2). The predetermined temperature may be, e.g., 65° C. to 70° C. If the air conditioning device 100 heats the first filter 150 to a predetermined temperature, carbon dioxide adsorbed to the first filter 150 may be desorbed.

According to an embodiment, the air conditioning device 100 may regenerate the first filter 150 by desorbing carbon dioxide adsorbed to the first filter 150. The regeneration performance of the regenerated first filter 150 may be maintained at 93%. The adsorption performance of the regenerated first filter 150 may be maintained at 98% to 99% compared to the performance before being regenerated.

According to an embodiment, the air conditioning device 100 may discharge carbon dioxide desorbed from the first filter 150 outdoors without passing through the heat exchanger 140. To that end, the air conditioning device 100 may open a bypass (or alternate) path.

For example, the air conditioning device 100 may open the first damper 121a provided in the first intake port 121 and open the ninth damper 139a provided at an upper side of the main body 110.

According to an embodiment, the RA may pass through the first intake port 121, pass through the first filter 150 provided in the first compartment C1, and then be discharged outdoors through the ninth damper 139a. For example, the air may be bypassed through a third discharge port (e.g., the third discharge port of FIG. 3) connected to the ninth damper 139a and discharged outdoors. To that end, the air conditioning device 100 may further include the third discharge port.

According to an embodiment, the air conditioning device 100 may introduce the OA into the air conditioning device 100 and supply the air, as the SA, indoors.

For example, the air conditioning device 100 may open the second damper 123a provided in the second intake port 123 and may open the fourth damper 127a provided in the first discharge port 127. The air conditioning device 100 may operate the first blower 171.

According to an embodiment, the air conditioning device 100 may discharge carbon dioxide adsorbed to the first filter 150 outdoors, purify the OA with the second filter 160, and supply the purified OA as the SA. The air conditioning device 100 may reduce the cooling and heating load by minimizing the thermal energy difference between the RA and the OA through the heat exchanger 140.

According to an embodiment, the air conditioning device 100 may simultaneously perform ventilation and regeneration of the first filter 150. The air conditioning device 100 may achieve energy reduction by minimizing a cooling load that may occur in the summer.

For example, if the air conditioning device 100 performs a ventilation operation in the summer, if the first filter 150 is heated to desorb carbon dioxide adsorbed to the first filter 150, the air passing through the first filter 150 may be heated to a predetermined temperature (e.g., 65° C. to 70° C.). If the air heated to the predetermined temperature is discharged outdoors through the heat exchanger 140 rather than the proposed air path Flow 4-2 (e.g., the air path according to Flow 4-1 of FIG. 9A), the OA may be supplied indoors through the heat exchanger 140, and the OA may be heated in the heat exchanger 140. Accordingly, the temperature of the RA may increase, and thus energy required for cooling may increase. The air conditioning device 100 may minimize an energy load required for cooling through the proposed air path Flow 4-2.

For example, it may be assumed that there are one or two occupants having a carbon dioxide emission amount of 18.7 L/h in an indoor space of 83 square meters (m²). The OA volume may be assumed to be 100 cubic meter per hour. It may be assumed that the driving time interval of the air conditioning device 100 is one hour. It may be assumed that the performance of the adsorbent applied to the first filter 150 is 2.5 mmol/g, and the amount of the adsorbent applied to the first filter 150 is 500 g. Under the above-described conditions, the air conditioning device 100 may maintain the concentration level of carbon dioxide contained in the RA at substantially 1000 ppm and at the same time reduce the ventilation rate to 0.23 ACH (air change per hour, the number of times of ventilation per hour, i.e., the number of times of exchange to clean air per hour in the recommended use area). Accordingly, the air conditioning device 100 may reduce the ventilation operation rate by about 49%. The air conditioning device 100 may provide energy reduction by reducing the ventilation operation time.

FIG. 10 is a flowchart illustrating an example subroutine for an automatic operation (e.g., the automatic mode of FIG. 4) in an air conditioning device 100 (e.g., the air conditioning device 100 of FIG. 1) according to an embodiment of the disclosure.

Referring to FIG. 10, in operation 1010, the air conditioning device 100 may detect a concentration of indoor carbon dioxide. The air conditioning device 100 may detect the concentration of carbon dioxide contained in the RA through a gas sensor.

According to an embodiment, in operation 1020, the air conditioning device 100 may determine whether the indoor carbon dioxide concentration level exceeds a threshold level. The threshold level may be set by the user or initially set carbon dioxide value. The threshold level may be, e.g., 1200 ppm.

According to an embodiment, if the level of indoor carbon dioxide concentration detected by the air conditioning device 100 exceeds the threshold level, the air conditioning device 100 may switch to the circulation mode and operate in operation 1030. In order to switch to the circulation mode, the air conditioning device 100 may execute the circulation mode subroutine of FIG. 5.

According to an embodiment, in operation 1040, the air conditioning device 100 may determine whether the indoor carbon dioxide concentration level is equal to or less than a threshold level. The threshold level may be, e.g., 1000 ppm.

According to an embodiment, if the indoor carbon dioxide concentration level is higher than the threshold level, in operation 1050, the air conditioning device 100 may determine whether the first filter (e.g., the first filter 150 of FIG. 3) is in a saturated state. The air conditioning device 100 may determine whether the first filter 150 is in the saturated state through the gas sensor that detects the concentration of the carbon dioxide collected in the first filter 150.

According to an embodiment, if it is determined that the indoor carbon dioxide concentration level is less than or equal to the threshold level or that the first filter 150 is in the saturated state, the air conditioning device 100 may switch to the ventilation mode and operate in operation 1060. In order to switch to the ventilation mode, the air conditioning device 100 may execute the circulation mode subroutine of FIG. 7.

FIG. 11 is a front view illustrating that the RA is discharged outdoors through a bypass path in an air conditioning device according to an embodiment of the disclosure. The air conditioning device 100 may discharge the RA outdoors through the path Flow 6 proposed in FIG. 11. If the air conditioning device 100 discharges the RA outdoors, the air conditioning device 100 may further include a separate component so that the OA is not introduced indoors.

Referring to FIG. 11, in the air conditioning device 100, in addition to the path illustrated in FIG. 9B, the RA may be discharged outdoors without passing through the heat exchanger 140.

According to an embodiment, the air conditioning device 100 may desorb carbon dioxide adsorbed to the first filter 150 and discharge it outdoors.

According to an embodiment, the air conditioning device 100 may heat the first filter 150 to a predetermined temperature to desorb carbon dioxide adsorbed to the first filter 150. The air conditioning device 100 may heat the first filter 150 by operating a heater (e.g., the heater unit 251 of FIG. 2). The predetermined temperature may be, e.g., 65° C. to 70° C. If the air conditioning device 100 heats the first filter 150 to a predetermined temperature, carbon dioxide adsorbed to the first filter 150 may be desorbed.

According to an embodiment, the air conditioning device 100 may regenerate the first filter 150 by desorbing carbon dioxide adsorbed to the first filter 150. The regeneration performance of the regenerated first filter 150 may be maintained at 93%. The adsorption performance of the regenerated first filter 150 may be maintained at 98% to 99% compared to the performance before being regenerated.

According to an embodiment, the air conditioning device 100 may discharge carbon dioxide desorbed from the first filter 150 outdoors without passing through the heat exchanger 140. To that end, the air conditioning device 100 may open a bypass path.

According to an embodiment, the air conditioning device 100 may open the first damper 121a provided in the first intake port 121. The air conditioning device 100 may open the fifth damper 131a provided on the first partition wall 131. The air conditioning device 100 may open the sixth damper 133a provided on the second partition wall 133. The air conditioning device 100 may open the third damper 125a provided in the second discharge port 125.

According to an embodiment, the RA may pass through the first intake port 121 and move from the first compartment C1 to the second compartment C2 without passing through the heat exchanger 140. The air may be guided from the second compartment C2 to the third compartment C3. The air may pass through the second discharge port 125 in the third compartment C3 and be discharged outdoors.

According to an embodiment, the air conditioning device 100 may include a separate opening/closing means (not shown) to prevent the RA in the second compartment C2 from moving to the fourth compartment C4 through the heat exchanger 140. For example, the opening/closing means may be provided near the heat exchanger 140 and preferably may be provided near the second plate 143. The opening/closing means may be implemented as a damper, but is not limited thereto, and may be implemented as a valve, an orifice, or a screen. For example, if the opening/closing means is implemented as any one of a damper, a valve, or an orifice, the air conditioning device 100 may prevent air from moving from the second compartment C2 to the fourth compartment C4 through the heat exchanger 140 by opening or closing the opening/closing means. For example, if the opening/closing means is implemented as a screen, the screen may include a material including metal or plastic to prevent fluid from passing therethrough. One end of the screen may be hinged to, e.g., one end of the second plate 143. As one end of the screen is hinged to one end of the second plate 143, the screen may block a surface of the second plate 143. The air conditioning device 100 may prevent air staying in the second compartment C2 from moving to the fourth compartment C4 through the heat exchanger 140 by allowing the screen to block the second plate 143.

According to an embodiment, as the air moves along the proposed path, the air conditioning device 100 may discharge the RA outdoors without supplying the OA indoors. The air conditioning device 100 may reduce the cooling and heating load by minimizing the thermal energy difference between the RA and the OA through the heat exchanger 140.

According to an embodiment, the air conditioning device 100 may discharge the RA outdoors without supplying the OA indoors. In discharging the RA outdoors, the air conditioning device 100 may heat the first filter 150 to remove carbon dioxide adsorbed to the first filter 150 and regenerate the first filter 150.

According to an embodiment, the air conditioning device 100 may simultaneously perform ventilation and regeneration of the first filter 150. The air conditioning device 100 may achieve energy reduction by minimizing a cooling load that may occur in the summer.

An air conditioning device 100 according to an embodiment of the disclosure may include a main body 110. The air conditioning device 100 may be provided with a first intake port 121 and a first discharge port 127 on one side 111 facing indoors. The air conditioning device 100 may be provided with a second intake port 123 and a second discharge port 125 on another side 113 facing outdoors. The air conditioning device 100 may include a main body 110 configured to form an air passage from the first intake port 121 to either the first discharge port 127 or the second discharge port 125 based on an operation state. The main body 110 may include a carbon dioxide suction filter 150 provided in a section where a first air passage connecting the first intake port 121 and the first discharge port 127 and a second air passage connecting the first intake port 121 and the second discharge port 127 are common (or shared). The main body 110 may include a heater 251 configured to heat the carbon dioxide suction filter 150 to a predetermined temperature in a ventilation operation state of discharging RA outdoors and supplying OA indoors.

In the air conditioning device 100 according to an embodiment, a suction capacity of the carbon dioxide suction filter 150 may be 1.5 mmol/g to 2.5 mmol/g.

The air conditioning device 100 according to an embodiment may include a first damper 121a configured to open or close the first intake port 121. The air conditioning device 100 may include a second damper 127a configured to open or close the first discharge port 127. The air conditioning device 100 may include a third damper 123a configured to open or close the second intake port 123. The air conditioning device 100 according to an embodiment of the disclosure may include a fourth damper 125a configured to open or close the second discharge port 125.

In the air conditioning device 100 according to an embodiment, the heater 251 may be configured to heat the carbon dioxide suction filter 150 to 65° C. to 70° C.

In the air conditioning device 100 according to an embodiment, the carbon dioxide suction filter 150 may include an adsorbent composed of a material in which carbon nanofibers, nanoparticles, and an amine group are combined at a predetermined component ratio.

In the air conditioning device 100 according to an embodiment, the carbon nanofibers may include CNTs or GNFs.

In the air conditioning device 100 according to an embodiment, the nanoparticles may include silicon dioxide (SiO₂), aluminum oxide (Al₂O₃), iron oxide (Fe₃O₄), or titanium dioxide (TiO₂).

In the air conditioning device 100 according to an embodiment, the amine group may include polyethylenimine PEI, 3-aminopropyl triethoxysilane, tetraethylenepentamine, or diethylenetriamine.

In the air conditioning device 100 according to an embodiment, a molecular weight of the amine group may meet 600 to 25,000.

In the air conditioning device 100 according to an embodiment, the material constituting the adsorbent may have a bead shape through a phase inversion method.

In the air conditioning device 100 according to an embodiment, the carbon dioxide suction filter 150 may include an adsorbent formed of a material in which an amine group is bonded to at least one synthetic resin-based adsorbent.

In the air conditioning device 100 according to an embodiment, the material constituting the adsorbent may have a capsule form through a phase inversion method.

A method for driving an air conditioning device 100 according to an embodiment may include determining 410, 420 an operation type. The driving method may include selecting 440 a ventilation operation for discharging the RA and supplying the OA among the operation types and heating 720 a carbon dioxide suction filter 150 to a predetermined temperature. The driving method may include discharging the RA outdoors and supplying the OA indoors.

The method for driving the air conditioning device 100 according to an embodiment may include forming the discharge passage Flow 4-1 by opening a first intake port 121 and a second discharge port 125 in response to determining that the operation type is the ventilation operation 440.

The method for driving the air conditioning device 100 according to an embodiment may include forming the discharge passage Flow 4-2 by opening a first intake port 121 and a third discharge port and opening a ninth damper 139a connecting a passage between a first compartment C1 and the third discharge port in response to determining that the operation type is the ventilation operation 440.

In the method for driving the air conditioning device 100 according to an embodiment, the predetermined temperature may be 65° C. to 70° C.

The method for driving the air conditioning device 100 according to an embodiment may include forming (510, 520, 530, 540, 550) an air flow Flow 1 so that adsorbed RA passes through the carbon dioxide suction filter and is purified and is then discharged indoors in response to determining that the operation type is a circulation operation 430.

In the method for driving the air conditioning device 100 according to an embodiment, forming the air flow Flow 1 may include opening 510 a first intake port 121. Forming the air flow Flow 1 may include closing 520 a second discharge port 125. Forming the air flow Flow 1 may include opening 530 a passage between a second compartment C2 and a third compartment C3. Forming the air flow Flow 1 may include closing 540 a second intake port 123, forming the air flow Flow 1 may include opening 550 a first discharge port 127.

The method for driving the air conditioning device 100 according to an embodiment may include detecting 1010 an indoor carbon dioxide concentration in response to determining that the operation type is an operation 460 for automatically driving the air conditioning device 100. The driving method may include, if the carbon dioxide concentration level exceeds a first threshold level, determining 1030 that the operation type is the circulation operation.

In the method for driving the air conditioning device 100 according to an embodiment, the first threshold level may be 1200 ppm.

The method for operating the air conditioning device 100 according to an embodiment may include, if the carbon dioxide concentration level is equal to or less than a second threshold level or if a suction capacity of the carbon dioxide suction filter is exceeded, determining 1060 that the operation type is the ventilation operation.

In the method for driving the air conditioning device 100 according to an embodiment, the second threshold level may be 1000 ppm.

In the method for driving the air conditioning device 100 according to an embodiment, the second threshold level may be relatively lower than the first threshold level.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., a program) including one or more instructions that are stored in a storage medium (e.g., internal memory or external memory) that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An air conditioning device comprising:
a main body provided with a first intake port through which indoor air is movable from an indoor area, a first discharge port through which supply air is movable to the indoor area, a second intake port through which outdoor air is movable from an outdoor area, and a second discharge port through which exhaust air is movable to the outdoor area; and
wherein the main body includes:
a carbon dioxide suction filter provided in a section where a first air passage connecting the first intake port and the first discharge port and a second air passage connecting the first intake port and the second discharge port are common; and
a heater configured to heat the carbon dioxide suction filter to a predetermined temperature based on an operation state of which the air conditioning device discharge indoor air to the outdoor area and supply outdoor air to the indoor area.

2. The air conditioning device of claim 1, wherein
a suction capacity of the carbon dioxide suction filter is 1.5 mmol/g to 2.5 mmol/g.

3. The air conditioning device of claim 1, further comprising:
at least one of a first damper configured to open and close the first intake port, a second damper configured to open and close the first discharge port, a third damper configured to open and close the second intake port, and a fourth damper configured to open and close the second discharge port.

4. The air conditioning device of claim 1, wherein
the heater is configured to heat the carbon dioxide suction filter to 65° C. to 70° C.

5. The air conditioning device of claim 1, wherein
the carbon dioxide suction filter includes an adsorbent including a material in which carbon nanofibers, nanoparticles, and an amine group are combined at a predetermined component ratio,
the carbon nanofibers include carbon nanotubes (CNTs) and/or graphene nanofibers (GNFs),
the nanoparticles include at least one of silicon dioxide (SiO₂), aluminum oxide (Al₂O₃), iron oxide (Fe₃O₄), and titanium dioxide (TiO₂), and
the amine group includes at least one or polyethylenimine (PEI), 3-aminopropyl triethoxysilane, tetraethylenepentamine, and diethylenetriamine.

6. The air conditioning device of claim 5, wherein
a molecular weight of the amine group is 600 to 25,000.

7. The air conditioning device of claim 5, wherein
the material of the adsorbent has a bead shape through a phase inversion method.

8. The air conditioning device of claim 1, wherein
the carbon dioxide suction filter includes an adsorbent formed of a material in which an amine group is bonded to at least one synthetic resin-based adsorbent, and
the material of the adsorbent has a capsule form through a phase inversion method.

9. The air conditioning device of claim 1, further comprising:
the heater configured to heat the carbon dioxide suction filter to a predetermined temperature based on an operation state of the air conditioning device, and
wherein the air condition device is configured so that:
in a circulation operation state, a first air passage connecting the first intake port and the first discharge port is formed such that indoor air is moved from the indoor area through the first intake port, thereafter through the carbon dioxide suction filter, and thereafter through the first discharge port to the indoor area as supply air without the heater heating the carbon dioxide suction filter, and
in a ventilation operation state:
a second air passage connecting the first intake port and the second discharge port is formed such that indoor air is moved from the indoor area through the first intake port, thereafter through the carbon dioxide suction filter, and thereafter through the second discharge port to the outdoor area as exhaust air while the heater heats the carbon dioxide suction filter, and
a third air passage connecting the second intake port to the first discharge port is formed such that outdoor air is moved from the outdoor area through the second intake port, and thereafter through the first discharge port to the indoor area as supply air.

10. The air conditioning device of claim 1, further comprising:
a bypass damper through which bypass exhaust air is movable to the outdoor area,
wherein the air condition device is configured so that:
in a bypass ventilation operation state:
a fourth air passage connecting the first intake port and the bypass damper is formed such that indoor air is moved from the indoor area through the first intake port, thereafter through the carbon dioxide suction filter, and thereafter through the bypass damper to the outdoor area as bypass exhaust air while the heater heats the carbon dioxide suction filter, and
the third air passage connecting the second intake port to the first discharge port is formed such that outdoor air is moved from the outdoor area through the second intake port, and thereafter through the first discharge port to the indoor area as supply air.

11. A method for driving an air conditioning device including a first intake port through which indoor air is movable from an indoor area, a first discharge port through which supply air is movable to the indoor area, a second intake port through which outdoor air is movable from an outdoor area, a second discharge port through which exhaust air if movable to the outdoor area, a carbon dioxide suction filter, and a heater configured to heat the carbon dioxide suction filter to a predetermined temperature based on an operation state of the air conditioning device, the method comprising:
determining whether a current operation state is a circulation operation state or a ventilation operation state; and
if the determined current operation state is the ventilation operation state to discharge indoor air to the outdoor area and supply outdoor air to the indoor area:
heating the carbon dioxide suction filter to a predetermined temperature in response to determining that the operation state is the ventilation operation state for discharging the indoor air outdoors and supplying outdoor air indoors.

12. The method of claim 11,
if the determined current operation state is the circulation operation state, forming a first air passage connecting the first intake port and the first discharge port such that indoor air is moved from the indoor area through the first intake port, thereafter through the carbon dioxide suction filter, and thereafter through the first discharge port to the indoor area as supply air, without operating the heater to heat the carbon dioxide suction filter, and
if the determined current operation state is the ventilation operation state:
forming a second air passage connecting the first intake port and the second discharge port such that indoor air is moved from the indoor area through the first intake port, thereafter through the carbon dioxide suction filter, and thereafter through the second discharge port to the outdoor area as exhaust air, while operating the heater to heat the carbon dioxide suction filter, and
forming a third air passage connecting the second intake port to the first discharge port such that outdoor air is moved from the outdoor area through the second intake port, and thereafter through the first discharge port to the indoor area as supply air.

13. The method of claim 11, the air conditioning device including a bypass damper through which bypass exhaust air is movable to the outdoor area, the method further comprising:
determining whether a current operation state is a bypass ventilation operation state; and
if the determined current operation state is the bypass ventilation operation state:
forming a fourth air passage connecting the first intake port and the bypass damper such that indoor air is moved from the indoor area through the first intake port, thereafter through the carbon dioxide suction filter, and thereafter through the bypass damper to the outdoor area as bypass exhaust air, while operating the heater to heat the carbon dioxide suction filter, and
forming the third air passage connecting the second intake port to the first discharge port such that outdoor air is moved from the outdoor area through the second intake port, and thereafter through the first discharge port to the indoor area as supply air.

14. The method of claim 11, wherein the operating the heater to heat the carbon dioxide suction filter includes heating the carbon dioxide suction filter to 65° C. to 70° C.

15. The method of claim 11, further comprising:
detecting an indoor carbon dioxide concentration level; and
based on the detected carbon dioxide concentration level exceeding a first threshold level, determining that the current operation state is the circulation operation state.

16. The method of claim 15, wherein the first threshold level is 1200 ppm.

17. The method of claim 15, further comprising:
based on the detected carbon dioxide concentration level being less than or equal to a second threshold level, or based on a suction capacity of the carbon dioxide suction filter being exceeded, determining that the current operation state is the ventilation operation state,
wherein the second threshold level is lower than the first threshold level.

18. The method of claim 17, wherein the second threshold level is 1000 ppm.

19. A method of controlling an air conditioning device including a first flow passage through which indoor air is movable from an indoor area to an outdoor area, a carbon dioxide suction filter in the first flow passage, a heater to heat the carbon dioxide suction filter, and a second flow passage through which outdoor air is movable from the outdoor area to the indoor area, the method comprising:
operating the air conditioning device in a ventilation mode in which indoor air is drawn from an indoor area into the first passage and passed through a carbon dioxide suction filter before being discharged to an outdoor area, and in which outdoor air is draw from an outdoor area into second flow passage and discharged into the indoor area; and
heating the carbon dioxide suction filter to a predetermined temperature while operating the air conditioning device in the ventilation mode.

20. The method of claim 19, wherein the operating the heater to heat the carbon dioxide suction filter includes heating the carbon dioxide suction filter to 65° C. to 70° C.
